(19) United States
(12) Patent Application Publication
(10) Pub. No.: US 2015/0154347 A1
(43) Pub. Date: Jun. 4, 2015

(54) SYSTEM AND METHOD FOR CONSTRAINED MULTISTATE REACTION PATHWAY DESIGN

(71) Applicant: California Institute of Technology, Pasadena, CA (US)

(72) Inventors: Brian R. Wolfe, Pasadena, CA (US); Robert Dirks, Larchmont, NY (US); Joseph N. Zadeh, San Francisco, CA (US); Niles A. Pierce, Pasadena, CA (US)

(21) Appl. No.: 14/497,070

(22) Filed: Sep. 25, 2014

Related U.S. Application Data
(60) Provisional application No. 61/883,405, filed on Sep. 27, 2013.

(51) Int. Cl. G06F 19/18; G06F 19/12

(52) U.S. Cl. CPC G06F 19/18; G06F 19/12

(57) ABSTRACT

Methods and systems for designing the sequences of multiple nucleic acid strands intended to hybridize in solution via a prescribed reaction pathway are described. Sequence design is formulated as a multistate optimization problem using a set of target test tubes containing different subsets of the strands to represent reactant, intermediate, and product states of the system. Each target test tube contains a set of desired “on-target” complexes, each with a target secondary structure and target concentration, and a set of undesired “off-target” complexes, each with vanishing target concentration. Optimization of the equilibrium ensemble properties of the target test tubes may implement both a positive design paradigm, explicitly designing for on-pathway states, and a negative design paradigm, explicitly designing against off-pathway states.

### CROSS-REFERENCE TO RELATED APPLICATIONS

This application claims priority to U.S. Provisional Application No. 61/883,405 filed on Sep. 27, 2013 and hereby incorporates by reference all of the contents described therein.

### GOVERNMENTAL RIGHTS

This work was funded by the National Science Foundation via the Molecular Programming Project (NSF-CCF-0832824 and NSF-CCF-1317694). The government has rights in this invention.

### BACKGROUND OF THE INVENTION

The programmable chemistry of nucleic acid base pairing has proven a fertile design space for engineering pathway-controlled self-assembly and disassembly processes. However, it remains an error-prone and time-consuming process to design nucleic acid sequences in a computer system so as to engineer a desired reaction pathway.

### BRIEF DESCRIPTION OF THE DRAWINGS

FIG. 1 is a diagram depicting certain embodiments of an ensemble decomposition of a parent node using one or more split-points sandwiched by base pairs. FIG. 1a is a diagram depicting an embodiment of an ensemble decomposition by hierarchically partitioning the structural ensemble using a split-point. FIG. 1b is a diagram depicting an embodiment of an ensemble decomposition and elimination of decomposition defects by redecomposing a parental ensemble using a set of multiple exclusive split-points.

FIG. 2 is a diagram depicting a structure-guided hierarchical ensemble decomposition of an on-target complex.

FIG. 3 depicts an example of a reaction pathway for conditional self-assembly via hybridization chain reaction (HCR).

FIG. 4 depicts an example of a reaction pathway for conditional Dicer substrate formation.

FIG. 5 depicts an example of a reaction pathway for Boolean logic AND gate.

FIG. 6 describes embodiments of metastable hairpins which undergo conditional catalytic self-assembly to form a 3-arm branched junction.

FIG. 7 describes an embodiment including two input molecules with sequences, T1, and T2, cooperatively binding to a Boolean logic gate to displace an output strand.

FIG. 8 depicts example target test tubes for designing conditional self-assembly via hybridization chain reaction.

FIG. 9 describes an embodiment showing a sample set of five target test tubes used to perform sequence design for conditional Dicer substrate formation for the reaction pathway of FIG. 4.

FIG. 10 depicts an embodiment with target test tubes for designing a Boolean logic AND gate.

FIG. 11 describes sample target test tubes used to perform sequence design for conditional self-assembly of a 3-arm junction.

FIG. 12 describes the target test tubes used to perform sequence design for cooperative hybridization using Boolean logic AND gates.

FIG. 13 depicts an evaluation of sequence design quality for two HCR systems (as described in FIG. 3) that are engineered to operate orthogonally.

FIG. 14 is a plot showing the median performance over 10 sample design trials for design quality, design cost, and relative design cost.

FIG. 15 shows the effect of preventing sequence patterns on the quality and cost of design.

FIG. 16 shows the effect of constraining sequence composition on the quality and cost of design.

FIG. 17 shows the performance of an embodiment of a test tube design process when using structural defect weighting.

FIG. 18 shows the effect of using structural weights for certain target structure from a designed system.

FIG. 19 is a block diagram depicting certain embodiments of a reaction pathway design system and various modules therein.

### SUMMARY OF THE INVENTION

Described herein are systems and processes for designing the sequence of one or more interacting nucleic acid strands intended to hybridize in solution via a prescribed reaction pathway. Sequence design is formulated as a multistate optimization problem using a virtual set of target test tubes containing different subsets of strands to represent reactant, intermediate, and product states of the system. Each target test tube programmed in the system contains a set of desired “on-target” complexes, each with a target secondary structure and target concentration, and a set of undesired “off-target” complexes with vanishing target concentration. Sequences can be designed subject to diverse classes of user-specified sequence constraints. Constrained multistate sequence design is performed to facilitate the nucleic acid reaction pathway engineering described herein.

As described in more detail below, in accordance with one aspect, an electronic system for determining the suitability of candidate nucleic acid strands to hybridize in solution via a target reaction pathway includes a set of virtual target test tubes representing reactants, intermediates, or products in the target reaction pathway, each virtual target test tube comprising data representing on-target complexes each having a target secondary structure and a target concentration, and off-target complexes each having vanishing target concentration; one or more sequence constraints inherent to the reaction pathway; a mutations module configured to generate a feasible candidate sequence that satisfies the one or more sequence constraints; and an objective function module configured to calculate a design objective function that quantifies the quality of a feasible candidate sequence based on physical properties calculated over the set of target test tubes.

In accordance with another aspect, an electronic system for optimizing the sequence of one or more nucleic acid strands to hybridize in solution via a target reaction pathway includes a set of virtual target test tubes representing reactants, intermediates, or products in the target reaction pathway, each virtual target test tube comprising data representing on-target complexes each having a target secondary structure and a target concentration, and off-target complexes each having a vanishing target concentration; one or more sequence constraints; a mutations module configured to generate a feasible candidate sequence that satisfies the one or more sequence constraints; an objective function module configured to evaluate the quality of a feasible candidate sequence based on physical properties calculated over the set of target test tubes; a test tube ensemble focusing module configured to define a focused ensemble within each target test tube comprising a subset of the complexes within the target test tube; a hierarchical ensemble decomposition module configured to decompose each complex in the focused ensemble into a tree of conditional subensembles, yielding a forest of decomposition trees; and an estimations module configured to optimize the sequence by accepting or rejecting a feasible candidate sequence based on conditional physical properties calculated at any level within the forest of decomposition trees.

In accordance with another aspect, a computer-implemented method for determining the suitability of candidate nucleic acid strands to hybridize in solution via a target reaction pathway comprises representing reactants, intermediates, or products in the target reaction pathway using a set of virtual target test tubes, each virtual target test tube comprising data representing on-target complexes each having a target secondary structure and a target concentration, and off-target complexes each having vanishing target concentration; determining one or more sequence constraints inherent to the reaction pathway; generating a feasible candidate sequence that satisfies the one or more sequence constraints; and calculating a design objective function that quantifies the quality of a feasible candidate sequence based on physical properties calculated over the set of target test tubes.

### DETAILED DESCRIPTION

Embodiments of the invention relate to systems and processes for designing nucleic acid molecules intended to hybridize in solution via a prescribed reaction pathway. In one embodiment, to enable sequence design for reaction pathway engineering, a multistate test tube design process is used to build on subsidiary engineering processes. These subsidiary engineering processes can include: complex design, test tube design, and multistate complex design. Such a multistate test tube design process may take into consideration various sequence constraints, pathway constraints, etc. The process may employ a test tube ensemble focusing module to focus design effort within the ensemble of the test tube. The process may also employ a hierarchical ensemble decomposition module to decompose target test tubes into a decomposition forest. The multistate test tube design process may also employ an estimation module to estimate whether a stop condition has been satisfied based on calculations performed efficiently at any level in the decomposition forest. The process may also employ an objective function module to calculate exactly (at higher cost) whether a stop condition has been satisfied over the full ensemble of the test tube. Finally, the process may employ a mutations module programmed to generate candidate sequences based on the various sequence constraints placed on each nucleic acid sequence in the design.

Specifically, in some embodiments, for complex design, the goal may be to design equilibrium base pairing properties of a single complex of one or more interacting nucleic acid strands. A complex design may utilize a complex ensemble defect optimization process that implements both a positive design paradigm, which explicitly designs for on-target structures, and a negative design paradigm that designs against off-target structures. However, complex design does not usually consider the concentration of the single on-target complex or the concentrations of any off-target complexes. As a result, sequences that are successfully optimized to stabilize a target secondary structure in the context of the on-target complex, may nonetheless fail to ensure that this complex forms at appreciable concentration when the actual molecules of each designed strand are synthesized and introduced into a physical test tube. To address this issue, one embodiment of the invention includes a computerized process of “test tube design” which expands the design ensemble and aims at properly engineering the equilibrium base-pairing properties of the actual molecules within a physical test tube of interacting nucleic acid strands. Within the systems described herein, a virtual target test tube may be specified as containing on-target complexes and off-target complexes. The goal of this system may be to design a set of sequences so that the normalized test tube ensemble defect satisfies the test tube stop condition so that the on-target complex will form at approximately the target concentration and predominantly adopt the target secondary structure at equilibrium if the constituent molecules are synthesized and placed within a container, such as a test tube, by a researcher.

But neither complex design nor test tube design address the multistate challenges inherent in reaction pathway engineering. To facilitate reaction pathway engineering, the multistate complex design process builds on the complex design process. For multistate complex design, the goal includes engineering the equilibrium base pairing properties of an arbitrary number of complexes representing reactant, intermediate, and product states along the reaction pathway. And the goal is to design a set of sequences such that for each complex, the normalized complex ensemble defect satisfies a complex stop condition.

And to facilitate reaction pathway engineering while retaining the conceptual benefits of test tube design over complex design, the multistate test tube design process may build on the test tube design process and the complex design process. For example, a set of target test tubes may be specified and the number of target test tubes can be arbitrary. By employing a set of target virtual test tubes to represent reactant, intermediate, and product states along the reaction pathway, positive and negative design paradigms may be implemented along the reaction pathway in the system to facilitate the engineering of the pathway. The system may evaluate whether stop conditions have been met using the objective function module and estimations module. The objective function module may be configured to minimize or evaluate a multistate test tube ensemble defect of the target test tubes, in view of stop conditions. And the mutations module may be used to generate candidate sequences subject to sequence and pathway-specific constraints, such as base-pairing properties, G-C content requirements, and so forth.

Furthermore, to enable efficient estimation of test tube ensemble properties, test tube ensemble focusing initially focuses design effort on the on-target portion of the test tube ensemble. To further enable efficient estimation of test tube ensemble properties, structural ensembles may be hierarchically decomposed into trees of sub-ensembles, yielding a forest of decomposition trees as described herein. Such decomposition may be guided by target structure considerations, base-pairing probabilities, or both. In addition, feasible sequences may be generated by solving constraint satisfaction problems using sequence and pathway constraints, as discussed in more detail below. Such feasible sequences may be evaluated via calculation of a multistate defect estimate. The designed test tubes may be subject to evaluation, refocusing, and reoptimization, and sequences may be augmented (as nodes at various depths in a decomposed forest) as described herein. A modified sequence may also be a result of a leaf-reoptimization process using sequence reseeding, generated from a valid sequence selected from a current set of leaf sequences, instead of starting from a random sequence or a sequence previously selected as a starting point.

### Reaction Pathway Engineering

### Reaction Pathway Specification

Molecular programmers engineer nucleic acid reaction pathways using an ever-increasing variety of small conditional DNA (scDNA, alternatively scRNA) motifs that exploit diverse design elements to interact and change conformation via prescribed hybridization cascades. Modes of nucleating interactions include toe-hold/toehold, loop/toehold, loop/loop, and template/toehold hybridization. Modes of strand displacement include 3-way branch migration, 4-way branch migration, and spontaneous dissociation. To exert control over the order of self-assembly and disassembly events, scDNAs are sometimes designed to co-exist metastably (i.e., the molecules are kinetically trapped) or stably (i.e., the molecules are thermodynamically trapped), with the next step in the reaction pathway triggered either by a cognate molecular input detected from the environment or by a molecular output of a previous step in the reaction pathway. In some instances, principles for engineering conditional metastability include nucleation barriers, topological constraints, toehold sequestration, and template unavailability, while principles for engineering conditional stability include cooperativity and sequence transduction. These pathway-controlled self-assembly and disassembly reactions may be driven by the enthalpy of base pairing and the entropy of mixing. These design elements have enabled the rational design and construction of scDNAs executing diverse dynamic functions, including catalysis, signal amplification, sequence transduction, shape transduction, Boolean logic, and locomotion.

In some instances, devising a new reaction pathway is akin to molecular choreography, requiring conception of both the scDNA participants and the dance that they will execute via pathway-controlled self-assembly and disassembly operations. Once a new reaction pathway has been choreographed, the task remains of encoding the intended pathway-controlled interactions and conformation changes into the sequences of the constituent scDNAs. To program this dynamic function, the nucleic acid sequences may be designed so that the molecules predominantly execute the desired on-pathway interactions while avoiding off-pathway alternatives. Systems and methods for formulating and solving the sequence design problem for nucleic acid reaction pathway engineering are disclosed herein.

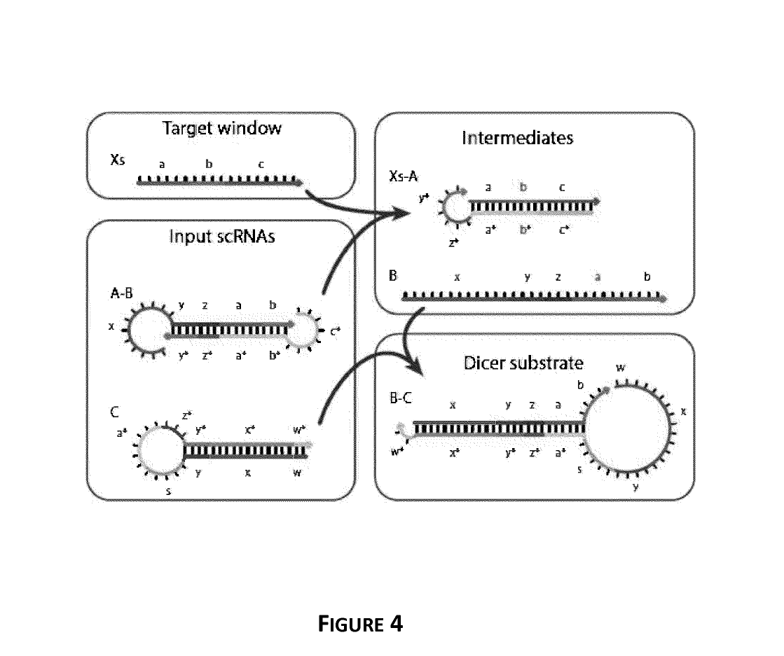

Consider a set of nucleic acid molecules intended to execute a prescribed hybridization cascade. For example, the reaction pathway of an embodiment depicted in FIG. 4 shows scRNAs that upon binding to input Xₛ, perform shape and sequence transduction to form a Dicer substrate targeting an independent output mRNA.

In this embodiment, the reaction pathway specifies the elementary self-assembly and disassembly operations by which the molecules are intended to interact, the desired secondary structure for each on-pathway complex, and the complementarity relationships between sequence domains in the molecules. For example, the reaction pathway in the embodiment in FIG. 4 describes two elementary steps (Step 1: Xₛ+A·B→Xₛ·A+B, Step 2: B+C→B·C) in terms of six on-pathway complexes (Xₛ, A·B, Xₛ·A, B, C, B·C), and numerous sequence domains (‘a*’ complementary to ‘a’, ‘b*’ complementary to ‘b’, and so on). A reaction pathway may, in some embodiments, explicitly specify a set of desired on-pathway states, and implicitly specify a set of undesired off-pathway states. In this embodiment, to design sequences that execute the reaction pathway, the reaction pathway engineering system 1901 may seek to implement both a positive design paradigm (explicitly designing for on-pathway states) and a negative design paradigm (explicitly designing against off-pathway states). Here, the reaction pathway engineering system 1901 formulates sequence design for reaction pathway engineering as a multistate optimization problem using a set of target test tubes to represent reactant, intermediate, and product states of the system.

### Multistate Test Tube Design Problem Specification

In some embodiments, a multistate test tube design problem can be specified as a set of target test tubes, Ω. Each tube, hεΩ, contains a set of desired on-target complexes, Ψₕ^{on}, and a set of undesired off-target complexes, Ψₕ^{off}. The set of complexes in tube h is then:

Ψₕ∝Ψₕ^{on}∪Ψₕ^{off}

and the set of all complexes in Ω is:

Ψ∝∪_{hεΩ}Ψₕ

For each on-target complex, jεΨₕ^{on}, the user or the reaction pathway engineering system 1901 may specify a target secondary structure, sⱼ, and a target concentration, y_{h,j}. For each off-target complex, jεΨₕ^{off}, the target concentration is vanishing (y_{h,j}=0) and there is no target structure (sⱼ=). When specifying off-targets, the reaction pathway engineering system 1901 may define Ψₕ^{off} to include all complexes of up to Lₘₐₓ strands. Let

φΨ∝φj∀jεΨ

denote the set of sequences for the complexes in Ω.

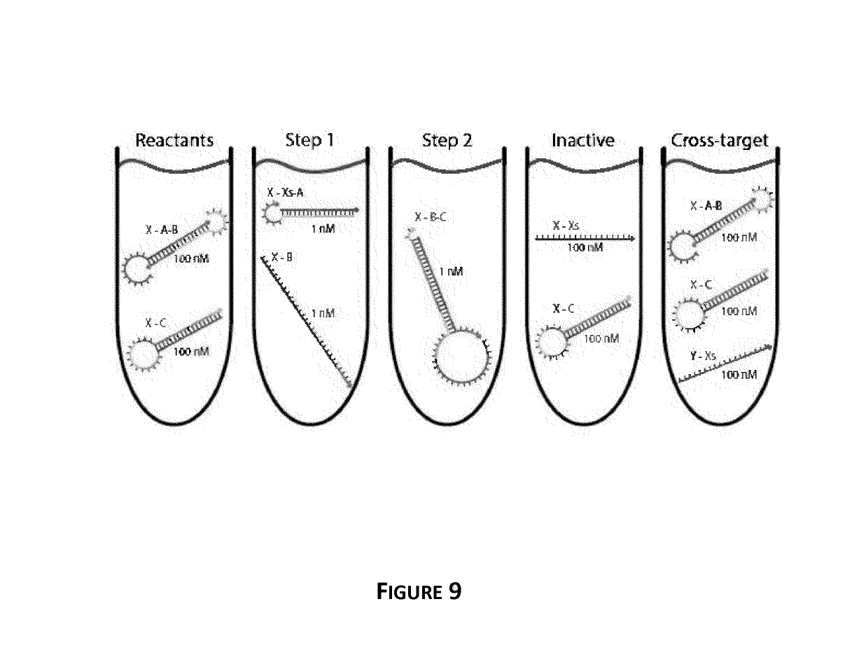

For a given reaction pathway, target test tubes can be used to represent reactant, intermediate, and product states of the system. For example, FIG. 9 describes an example embodiment with a set of five target test tubes for the reaction pathway of FIG. 4. Within each target test tube, each on-target complex is depicted by its target secondary structure labeled with its target concentration. Tube 1 contains the scRNA reactants A·B and C that should not interact in the absence of input Xₛ. Tube 2 contains the intermediates, Xₛ·A and B, that are the products of Step 1. Tube 3 contains the product B·C, that is the product of Step 2. Tube 4 contains the input Xₛ and the scRNA C that should not interact in the absence of scRNA A·B. Tube 5 contains the scRNA reactants A·B and C for the current system (so-called “system X” denoted by prefix “X”) that should not interact with the input Xₛ for an orthogonal system (so-called “system Y” denoted by prefix “Y”). In addition to the depicted on-target complexes, each of the five target test tubes contains all off-target complexes of up to size Lₘₐₓ=3, each with vanishing target concentration.

In one example, each target test tube isolates a different stable subset of the system components in local equilibrium, enabling optimization of kinetically significant states that would appear insignificant if all components were placed in a single test tube at equilibrium. For example, with the target test tubes of the embodiment shown in FIG. 9, placing scRNA A·B as an on-target in Tube 1 and input Xₛ as an on-target in Tube 2 enables specification of unstructured complementary toeholds ‘c’ in Xₛ and ‘c*’ in A·B suitable for mediating a rapid strand displacement interaction. Moreover, designing against the off-targets Xₛ·Xₛ and Xₛ·Xₛ·Xₛ in Tube 2 may ensure that the input Xₛ, is not only unstructured when in monomer form, but that this monomer dominates alternative multimer states, preserving its accessibility for rapid interactions with scRNA A·B. Optimizing the equilibrium properties of target test tubes representing kinetically significant states enables explicit positive design for on-pathway interactions and explicit negative design against off-pathway interactions.

### Design Objective Function

In one example, to provide a physically meaningful objective function for optimizing the equilibrium base-pairing properties of a single test tube of interacting nucleic acid strands, the reaction pathway engineering system 1901, and specifically, the objective function module 1910, may first derive the test tube ensemble defect, C, quantifying the concentration of incorrectly paired nucleotides at equilibrium evaluated over the ensemble of the target test tube (also described herein). In some embodiments, optimization of the test tube ensemble defect may implement a positive design paradigm (stabilize on-targets) and a negative design paradigm (destabilize off-targets) at two levels: (1) designing for the on-target structure and against the off-target structures within the structural ensemble of each on-target complex, and (2) designing for the on-target complexes and against the off-target complexes within the ensemble of the test tube. Both paradigms may be important at both levels in order to achieve high-quality test tube designs with a low test tube ensemble defect.

In this particular embodiment using the present multistate test tube design setting, let

ₕ∝Cₕ/yₕ^{nt}

denote the normalized test tube ensemble defect for tube hεΩ, which falls in the interval (0, 1). Here,

$${y}_{h}^{nt} ≡ {\sum }_{j ∈ {Ψ}_{h}^{on}} \vert {φ}_{j} \vert {y}_{h , j}$$

is the total concentration of nucleotides in tube h. As ₕ approaches zero, each on-target complex, jεΨₕ^{on}, approaches its target concentration, y_{h,j}, and is dominated by its target structure, sⱼ, and each off-target complex, jεΨₕ^{off}, forms with vanishing target concentration.

To quantify sequence quality over the set of target test tubes, Ω, the reaction pathway engineering system 1901 employs the multistate test tube ensemble defect,

$$ℳ = \frac{1}{\vert Ω \vert} {\sum }_{h ∈ Ω} {ℳ}_{h} , \qquad ( 1 )$$

representing the average normalized test tube ensemble defect over Ω.

In one embodiment, the goal is to design a set of sequences, φ_{Ψ}, such that for each test tube, hεΩ, the normalized test tube ensemble defect, ₕ, satisfies a test tube stop condition,

ₕ≦fₕ^{stop}, (2)

for a user-specified value of fₕ^{stop}ε(0,1). To focus design effort on test tubes that do not yet satisfy (2), we modify (1) by thresholding the contribution of each test tube by its stop condition

$${ℳ}^{obj} = \frac{1}{\vert Ω \vert} {\sum }_{h ∈ Ω} max ( {ℳ}_{h} , {f}_{h}^{stop} ) .$$

In this embodiment, objective function module 1910 achieves the optimal value of the design objective function of:

$${f}_{stop} ≡ \frac{1}{\vert Ω \vert} {\sum }_{h ∈ Ω} {f}_{h}^{stop} \qquad ( 4 )$$

if and only if all test tubes satisfy (2). By construction, ≦ ^{obj}, so optimality for the design objective function ^{obj}, implies

≦fₛₜₒₚε(0,1) (5)

for the multistate test tube ensemble defect.

For design problems where it proves challenging to sufficiently reduce ^{obj} due to competing demands within the objective function, the user or the pathway engineering design system 1901 may wish to alter the weighting of various defect contributions within ^{obj} to prioritize or deprioritize design quality for a portion of the design ensemble. To provide flexibility

TABLE 1
SEQUENCE CONSTRAINTS.

| Constraint type | Constraint relation | Nucleotides |
|---|---|---|
| Assignment | (φ^{a)} ∈ Rₐ^{assignment} ≡ {(q^{a})} | 1 |
| Match | (φ^{a}, φ^{b}) ∈ R_{a,b}^{match} ≡ {(A, A), (C, C), (G, G), (U, U)} | 2 |
| Watson-Crick | (φ^{a}, φ^{b}) ∈ R_{a,b}^{WC} ≡ {(A, U), (C, G), (G, C), (U, A)} | 2 |
| Wobble | (φ^{a}, φ^{b}) ∈ R_{a,b}^{wobble} ≡ {(A, U), (C, G), (G, C), (U, A), (G, U), (U, G)} | 2 |
| Composition | (φ^{a}, . . . , φ^{b}) ∈ Rₐ . . . _{b}^{composition} ≡ {(φ^{a}, . . . , φ^{b})\|f^{min} ≦ Σᵢ₌ₐ . . . _{b} d(φⁱ, q¹)/n ≦ f^{max}} | b − a + 1 = n |
| Similarity | (φ^{a}, . . . , φ^{b}) ∈ Rₐ . . . _{b}^{similarity} ≡ {(φ^{a}, . . . , φ^{b})\|f^{min} ≦ d((φ^{a}, . . . , φ^{b}), (q¹, . . . , qⁿ))/n ≦ f^{max}} | b − a + 1 = n |
| Pattern prevention | (φ^{a}, . . . , φ^{b}) ∈ Rₐ . . . _{b}^{pattern} ≡ {(φ^{a}, . . . , φ^{b})\|(q¹, . . . , qⁿ) is not a subsequence of (φ^{a}, . . . , φ^{b})} | b − a + 1 ≧ n |
| Window | (φ^{a}, . . . , φ^{b}) ∈ Rₐ . . . _{b}^{window} ≡ {(φ^{a}, . . . , φ^{b})\|(φ^{a}, . . . , φ^{b}) is a subsequence of (q¹, . . . , qⁿ)} | b − a + 1 ≦ n |
| Library | (φ^{a}, . . . , φ^{b}) ∈ Rₐ . . . _{b}^{library} ≡ {(q₁¹, . . . , q₁ⁿ), . . . , (qₘ¹, . . . , qₘⁿ)} | b − a + 1 = n |

For user-specified q¹ ∈ {A, C, G, U, M, R, W, S, Y, K, V, H, D, B, N}.

for the user to adjust priorities at any level of organization within the design ensemble, the reaction pathway engineering system 1901 permits the user to define defect weights at three levels of organization within the design ensemble: nucleotide, complex, and test tube. In some embodiments, with the default value of unity for all weights, the objective function has a clear physical interpretation. With user-defined weights, the physical meaning is distorted in the service of adjusting design priorities. Following sequence design, the multistate test tube ensemble defect, , provides a physically meaningful characterization of sequence quality independent of user-defined stop conditions and defect weights.

### Sequence Constraints

A nucleic acid reaction pathway imposes implicit sequence constraints on the constituent scDNAs (e.g., the complementary sequence domains ‘a’ and ‘a*’ in the reaction pathway of FIG. 4). Furthermore, a molecular programmer or synthetic biologist may need to impose explicit sequence constraints in order to implement a desired function (e.g., input Xₛ, comprising sequence domains ‘a-b-c’ in FIG. 4, may need to be constrained to be a subsequence of a specific mRNA). Hence, for reaction pathway engineering, the reaction pathway engineering system 1901 may perform multistate sequence design subject to both implicit and explicit sequence constraints.

In some embodiments, the reaction pathway engineering system 1901 may employ a unified framework for handling diverse types of sequence constraints:
Assignment Constraint. Nucleotide a is constrained to have a specified sequence (e.g., A, C, G, U or any of the IUPAC degenerate nucleotide codes; see Table 4 for an example).
Match Constraint. Two nucleotides a and b are constrained to be identical (e.g., if a strand species appears in more than one on-target complex, corresponding nucleotides are constrained to have the same sequence in all complexes).
Watson-Crick Constraint. Two nucleotides a and b are constrained to be Watson-Crick complements (by default, Watson-Crick constraints are implied for all base pairs present in on-target structures).
Wobble Constraint. Two nucleotides a and b are constrained to be Watson-Crick or wobble complements. For design problems that place competing demands on the design objective function (e.g., if a strand is intended to base-pair differently in two on-target structures), permitting wobble complementarity gives the method additional flexibility in meeting these demands.
Composition Constraint. Consecutive nucleotides a, . . . , b are constrained to have a sequence composition in a specified range (e.g., a desired GC content can be achieved by constraining the fraction of S nucleotides to fall in the range [f^{min}, f^{max}]).
Similarity Constraint. Consecutive nucleotides a, . . . , b are constrained to be similar to a specified sequence of length n=b−a+1 to a specified degree (e.g., the fraction of nucleotides matching an mRNA sequence can be constrained to fall in the range [f^{min}, f^{max}]). The similarity constraint generalizes the assignment constraint and the composition constraint.
Pattern Prevention Constraint. Consecutive nucleotides a, . . . , b are constrained not to contain a specified subsequence of length n≦b−a+1 (e.g., prevention of GGGG, which is prone to forming G-quadruplexes that are not accounted for in nearest-neighbor free energy models).
Window Constraint. Consecutive nucleotides a, . . . , b are constrained to be a subsequence of a specified source sequence of length n≧b−a+1 (e.g., the source sequence is an mRNA).
Library Constraint. Consecutive nucleotides a, . . . , b are constrained to be selected from a specified library of m sequences of length n=b−a+1 (e.g., a library to toehold sequences or a library of codons). The library constraint generalizes the assignment constraint and the window constraint.

Each constraint can be expressed as a constraint relation, such as the examples shown in Table 1. Additional types of sequence constraints can be supported within this framework by specifying new constraint relations. For a given design problem, the reaction pathway engineering system 1901 may use to denote the set of user-specified sequence constraints.

### Constrained Multistate Sequence Design

In one embodiment, to design a set of sequences, φ_{Ψ}, for a nucleic acid reaction pathway, the reaction pathway engineering system 1901 may define a set of target test tubes, Ω, representing reactant, intermediate, and product states of the system, and formulate the constrained multistate sequence design problem as:

$${min}_{φψ} {ℳ}^{obj} subject to ℛ .$$

An optimal design would be satisfaction of the test tube stop condition (2) for all hεΩ, which in turn implies ≦fₛₜₒₚ.

### Theory

### Secondary Structure Model

In one embodiment, the sequence, φ, of one or more interacting RNA strands can be specified as a list of bases φ^{a}ε{A,C,G,U} for a=1, . . . . , |φ| (T replaces U for DNA). A secondary structure, s, of one or more interacting RNA strands can be defined by a set of base pairs (each a Watson-Crick pair [A·U or C·G] or a wobble pair [G·U]). A polymer graph representation of a secondary structure can be constructed by ordering the strands around a circle, drawing the backbones in succession from 5′ to 3′ around the circumference with a nick between each strand, and drawing straight lines connecting paired bases. A secondary structure is unpseudoknotted if there exists a strand ordering for which the polymer graph has no crossing lines. A secondary structure is connected if no subset of the strands is free of the others. A complex of interacting strands is specified as a strand ordering, π, corresponding to the structural ensemble, Γ, containing all connected polymer graphs with no crossing lines. For sequence and secondary structure, sεΓ, the free energy, ΔG(φ,s), may be calculated using nearest-neighbor empirical parameters for RNA in 1M Na⁺ or for DNA in user-specified Na⁺ and Mg⁺⁺ concentrations. These physical models have practical utility for the analysis and design of functional nucleic acid systems, and provide the basis for rational analysis and design of equilibrium base-pairing in the context of a dilute solution using the reaction pathway engineering system 1901.

### Analyzing Equilibrium Base-Pairing in a Virtual Test Tube.

In one embodiment, the reaction pathway engineering system 1901 uses Ψₕ⁰ to denote the set of strand species that interact in a test tube hεΩ to form the set of complex species Ψₕ. For complex jεΨₕ, with sequence φⱼ and structural ensemble Γⱼ, the partition function

$$Q ( {φ}_{j} ) = {\sum }_{s ∈ Γ j} exp [ - Δ G ( {φ}_{j} , s ) \text{/} {k}_{B} T ]$$

can be used to calculate the equilibrium probability of any secondary structure sεΓⱼ:

p(φⱼ,s)=exp[−ΔG(φⱼ,s)/k_{B}T]/Q(φⱼ).

Here, k_{B} is the Boltzmann constant and T is temperature. The equilibrium base-pairing properties of complex j can be characterized by the base-pairing probability matrix P (φⱼ), with entries P^{a,b}(φⱼ)ε[0,1] corresponding to the probability,

$${P}^{a , b} ( {φ}_{j} ) = {\sum }_{s ∈ {Γ}_{j}} p ( {φ}_{j} , s ) {S}^{a , b} ( s ) ,$$

that base pair a·b forms at equilibrium within ensemble Γⱼ. Here, S(s) is a structure matrix with entries S^{a,b}(s)=1 if structure s contains base pair a·b and S^{a,b}(s)=0 otherwise. For convenience, in some embodiments, the structure and probability matrices can be augmented with an extra column to describe unpaired bases. The entry S^{a,|s|+1}(s) is unity if base a is unpaired in structure s and zero otherwise; the entry P^{a,|φ}^{ⱼ}^{|+1}(φⱼ)ε[0,1] denotes the equilibrium probability that base a is unpaired over ensemble Γⱼ. Hence the row sums of the augmented S(s) and P(φⱼ) matrices are unity.

In one embodiment, the reaction pathway engineering system 1901 may use Q_{Ψ}^{h}∝Qⱼ∀jεΨₕ to denote the set of partition functions for the complexes in test tube h. The set of equilibrium concentrations, x_{h,Ψ}_{ₕ}, (specified as mole fractions) are the unique solution to the strictly convex optimization problem:

$$\begin{matrix}{min}_{{x}_{h} , {Ψ}_{h}} {\sum }_{j ∈ {Ψ}_{h}}^{ } {x}_{h , j} ( log {x}_{h , j} - log {Q}_{j} - 1 ) & ( 6 a ) \\ subject to {A}_{i , j} {x}_{h , j} = {x}_{h , i}^{0} ∀ i ∈ {Ψ}_{h}^{0} , & ( 6 b )\end{matrix}$$

where the constraints impose conservation of mass. A is the stoichiometry matrix with entries A_{i,j} corresponding to the number of strands of type i in complex j, and x_{h,i}⁰ is the total concentration of strand i introduced to test tube h.

In one embodiment, to analyze the equilibrium base-pairing properties of all test tubes hεΩ, the partition function, Q(φⱼ), and equilibrium pair probability matrix, P(φⱼ), may be generated for each complex jεΨ using θ(|φⱼ|³) dynamic programs. In some other embodiments, the reaction pathway engineering system 1901 may utilize other processes or methods. The equilibrium concentrations, x_{v,Ψ}_{ₕ}∀hεΩ may be generated by solving the convex programming problem (6) using an efficient trust region method at a cost that is typically negligible by comparison. The overall time complexity to analyze the test tubes in Ω may be O(|Ψ∥φ|ₘₐₓ³), where |φ|ₘₐₓ is the size of the largest complex.

In one scenario, calculation of the design objective function (3) may include calculation of the complex partition functions, Q_{Ψ}, which are used to calculate the equilibrium concentrations, x_{h,Ψ}_{ₕ}∀hεΩ, as well as the equilibrium pair probability matrices, P_{Ψ}_{^{on}}, which are used to calculate the complex ensemble defects, n_{Ψ}_{^{on}}, and the normalized test tube ensemble defects, _{Ω}. Hence, the time complexity to evaluate the multistate test tube ensemble defect over the set of target test tubes, Ω, is the same as the time complexity to analyze equilibrium base-pairing in Ω.

### Subsidiary Design Problems

To enable sequence design for reaction pathway engineering, the reaction pathway engineering system 1901 may solve the multistate test tube design problem, which builds conceptually on three subsidiary design problems that may be viewed as special cases of multistate test tube design: complex design, test tube design, and multistate complex design. Here, we describe the design ensemble, design objective function, and design paradigms for each design problem, and highlight interesting conceptual relationships between the approaches.

### Complex Design

For complex design, the goal is to design the equilibrium base pairing properties of a complex of (one or more) interacting nucleic acid strands. This subsidiary design problem is the foundation on which the other three design problems build, and has attracted the most engineering method development to date.

TABLE 2
NUCLEIC ACID SEQUENCE DESIGN ENSEMBLES.

| | | Per test tube h ∈ Ω | |
|---|---|---|---|
| | | On-target | Off-target |
| | Test tubes | complexes | complexes |
| Design problem | \|Ω\| | \|Ψₕ^{on}\| | \|Ψₕ^{off}\| |
| Complex design | 1 | 1 | 0 |
| Test tube design | 1 | Arbitrary | Arbitrary |
| Multistate complex design | Arbitrary | 1 | 0 |
| Multistate test tube design | Arbitrary | Arbitrary | Arbitrary |

Design Ensemble. For a complex design problem, the user may specify a target secondary structure, s, for the complex. The reaction pathway engineering system 1901 may view complex design as a special case of multistate test tube design where the design ensemble contains a single target test tube containing a single on-target complex and zero off-target complexes (Table 2).

Objective Function. To provide a physically meaningful basis for complex design, the complex ensemble defect may be used by the objective function module 1910

$$n ( {φ}_{j} , {s}_{j} ) = \vert {φ}_{j} \vert = {{\sum }_{1 \leq a \leq \vert {φ}_{j} \vert}}_{1 \leq b \leq \vert {φ}_{j} \vert + 1} {P}^{a , b} ( {φ}_{j} ) S ( {s}_{j} )$$

to quantify the average number of incorrectly paired nucleotides at equilibrium evaluated over the ensemble of complex j. Let

Nⱼ∝nⱼ/|φⱼ|

denote the normalized complex ensemble defect, which falls in the interval (0,1). The goal is to design a sequence, φⱼ, such that the normalized complex ensemble defect satisfies the complex stop condition,

Nⱼ≦fⱼ^{stop}

for a user-specified value of fⱼ^{stop}ε(0,1).

Design Paradigms. Complex ensemble defect optimization may implement both a positive design paradigm (explicitly designing for the on-target structure) and a negative design paradigm (explicitly designing against off-target structures) within the ensemble of the complex. In some embodiments, both paradigms can be important to achieving high sequence quality in the context of the complex. Because complex design may correspond to a test tube ensemble containing one on-target complex and zero off-target complexes, complex design may, in one embodiment, implement only a positive design paradigm at the level of the test tube ensemble (Table 3).

### Virtual Test Tube Design

With complex design, neither the concentration of the on-target complex, nor the concentrations of any off-target complexes are considered. As a result, sequences that are successfully optimized to stabilize a target secondary structure in the context of the on-target complex, may nonetheless fail to ensure that this complex forms at appreciable concentration when the strands are introduced into a test tube. To address this issue, test tube design expands the design ensemble. For test tube design, the goal of the reaction pathway engineering system 1901 is to engineer the equilibrium base-pairing properties of a test tube of interacting nucleic acid strands.

Design Ensemble. For a test tube design problem, the user or the system 1901 may specify a target test tube h containing on-target complexes, jεΨₕ^{on} (each with a target secondary structure, sⱼ, and a target concentration, y_{h,j}) and off-target complexes, jεΨₕ^{off} (each with vanishing target concentration). The reaction pathway engineering system 1901 may view test tube design as a special case of multistate test tube design where the design ensemble contains a single target test tube containing arbitrary numbers of on-target and off-target complexes (Table 2).

TABLE 3
NUCLEIC ACID SEQUENCE DESIGN PARADIGMS.

| | Paradigms within complex | | Paradigms within test tube | | Paradigms along pathway | |
|---|---|---|---|---|---|---|
| Design objective function | Positive | Negative | Positive | Negative | Positive | Negative |
| Complex ensemble defect | X | X | X | | | |
| Test tube ensemble defect | X | X | X | X | | |
| Multistate complex | X | X | X | | X | |
| ensemble defect | | | | | | |
| Multistate test tube | X | X | X | X | X | X |
| ensemble defect | | | | | | |

Objective Function. To provide a physically meaningful basis for test tube design, the test tube ensemble defect,

$$C ( {φ}_{{Ψ}_{h}} , {s}_{{Ψ}_{h}} , {y}_{h , {Ψ}_{h}} ) = {\sum }_{j ∈ {Ψ}_{h}^{on}} [ n ( {φ}_{j} , {s}_{j} ) min ( {x}_{h , j} , {y}_{h , j} ) + \vert {φ}_{j} \vert max ( {y}_{h , j} - {x}_{h , j} , 0 ) ] \qquad ( 7 )$$

quantifies the concentration of incorrectly paired nucleotides at equilibrium evaluated over the ensemble of the target test tube. Here, x_{h,j}, denotes the equilibrium concentration of complex j in tube h. For each on-target complex, jεΨₕ^{on}, in one embodiment, the first term in the sum represents the structural defect, quantifying the concentration of nucleotides that are in an incorrect base-pairing state on average within the ensemble of complex j. The second term in the sum represents the concentration defect, quantifying the concentration of nucleotides that are in an incorrect base-pairing state because there is a deficiency in the concentration of complex j. Note that in some embodiments, the reaction pathway engineering system 1901 may sum over Ψₕ^{on} rather than Ψₕ because y_{h,j}=0 for off-target complexes, so the structural and concentration defects are both identically zero for all jεΨₕ^{on}. This does not mean that the defects associated with off-targets are ignored in this embodiment. By conservation of mass, non-zero off-target concentrations imply deficiencies in on-target concentrations, and these concentration defects are quantified by (7). Let

ₕ∝Cₕ/yₕ^{nt}

denote the normalized test tube ensemble defect, which falls in the interval (0, 1). Here, yₕ^{nt}∝Σ_{jεΨ}_{ₕ}_{^{on}}|φⱼ|y_{h,j} is the total concentration of nucleotides in the test tube. The goal of the reaction pathway engineering system 1901 is to design a set of sequences, φ_{Ψh}, such that the normalized test tube ensemble defect satisfies the test tube stop condition,

ₕ≦fₕ^{stop}

for a user-specified value of fₕ^{stop}ε(0,1).

Design Paradigms. In one embodiment, test tube ensemble defect optimization implements a positive design paradigm and a negative design paradigm at two levels (Table 3): (1) designing for the on-target structure and against off-target structures within the structural ensemble of each on-target complex, and (2) designing for on-target complexes and against off-target complexes within the ensemble of the test tube. Both paradigms may in some embodiments be important at both levels in order to achieve high-quality test tube designs with a low test tube ensemble defect.

### Multistate Complex Design

Neither complex design nor test tube design addresses the multistate challenges inherent in reaction pathway engineering. To address this issue, multistate complex design builds on complex design to expand the design ensemble. For multistate complex design, the goal of the reaction pathway engineering system 1901 is to engineer the equilibrium base pairing properties of an arbitrary number of complexes representing reactant, intermediate, or product states along the reaction pathway.

Design Ensemble. In one embodiment, for a multistate complex design problem, the user may specify a set of complexes, jεΨ, each with a target secondary structure, sⱼ. The reaction pathway engineering system 1901 may view multistate complex design as a special case of multistate test tube design where the design ensemble contains an arbitrary number target test tubes each containing a single on-target complex and zero off-target complexes (Table 2).

Objective Function. To quantify sequence quality over the set of target complexes, Ψ, the multistate complex ensemble defect,

$$N = \frac{1}{\vert Ψ \vert} {\sum }_{j ∈ Ψ} {N}_{j} \qquad ( 8 )$$

represents the average normalized complex ensemble defect over Ψ. Here,

Nⱼ∝nⱼ(φⱼ,sⱼ)/|φⱼ|,

denotes the normalized complex ensemble defect for complex j, which falls in the interval (0,1). The goal of the reaction pathway engineering system 1901 is to design a set of sequences, φ_{Ψ}, such that for each complex jεΨ, the normalized complex ensemble defect may satisfy a complex stop condition,

Nⱼ≦fⱼ^{stop}; (9)

for a user-specified value of fⱼ^{stop}ε(0,1). To focus design effort on complexes that do not yet satisfy (9), the reaction pathway engineering system 1901 may modify (8) by thresholding the contribution of each complex by its stop condition

$${N}^{obj} = \frac{1}{\vert Ψ \vert} {\sum }_{j ∈ Ψ} max ( {N}_{j} , {f}_{j}^{stop} )$$

In one embodiment, this design objective function achieves its optimal value of

$${f}_{stop} ≡ \frac{1}{\vert Ψ \vert} {\sum }_{j ∈ Ψ} {f}_{j}^{stop} \qquad ( 11 )$$

if and only if all complexes satisfy (9). By construction, N≦N^{obj}, so optimality for the design objective function, N^{obj}, implies

N≦fₛₜₒₚε(0,1) (12)

for the normalized multistate complex ensemble defect.

Design Paradigms. In one embodiment, multistate complex ensemble defect optimization may implement both positive and negative design paradigms within the ensemble of each complex. Because each state in the multistate formulation corresponds to a test tube ensemble containing one on-target complex and zero off-target complexes, multistate complex design may, in some embodiments, implement only a positive design paradigm within the ensemble of each test tube. By designing for multiple states along the reaction pathway, multistate complex design using the reaction pathway engineering system 1901 also implements a positive design paradigm along the reaction pathway (Table 3).

### Multistate Test Tube Design

To facilitate reaction pathway engineering while retaining the conceptual benefits of test tube design over complex design, multistate test tube design using the reaction pathway engineering system 1901 builds on test tube design to expand the design ensemble.

Design Ensemble. For a multistate test tube design problem, the user may specify a set of target test tubes, Ω. Each tube hεΩ contains a set of on-target complexes, jεΨₕ^{on} (each with target secondary structure, sⱼ, and target concentration, y_{h,j}), and a set of off-target complexes, jεΨₕ^{off} (each with vanishing target concentration, y_{h,j}=0). In one embodiment, in contrast to the three subsidiary design problems, for multistate test tube design, the number of target test tubes can be arbitrary and the numbers of on- and off-target complexes within each target test tube are also arbitrary (see the embodiment described in Table 2).

Objective Function. To provide a physically meaningful basis for multistate test tube design, the multistate test tube ensemble defect, , quantifies the average normalized test tube ensemble defect over Ω, as described previously (1-5). When the design ensemble comprises a single target test tube containing a single on-target complex and no off-target complexes, the present formulation may be considered to be equivalent to complex ensemble defect optimization. When the design ensemble comprises a single target test tube containing arbitrary numbers of on-target and off-target complexes, the present formulation may be considered to be equivalent to test tube ensemble defect optimization. When the design ensemble comprises multiple target test tubes, each containing a single on-target complex and no off-target complexes, the present formulation is equivalent to multistate complex ensemble defect optimization. The multistate test tube ensemble defect generalizes the three subsidiary ensemble defects to an ensemble of an arbitrary number of target test tubes, each containing arbitrary numbers of on- and off-target complexes.

Design Paradigms. The present formulation may, in some embodiments, implement positive and negative design paradigms within the ensemble of each complex and also within the ensemble of each test tube. Moreover, by employing a set of target test tubes to design for on-pathway states and against off-pathway states along the reaction pathway, the present formulation used by the reaction pathway engineering system 1901 also implements positive and negative design paradigms along the reaction pathway (Table 3).

### Embodiments of the Pathway Engineering Process

### Pathway Engineering Process Overview

In some embodiments, the constrained multistate sequence design process used by the reaction pathway engineering system 1901 generalizes the test tube design process of Wolfe and Pierce, adapting similar process ingredients to perform sequence design over an ensemble of an arbitrary number of target test tubes subject to implicit and explicit sequence constraints. In some other embodiments, additional limitations may also be added to the engineering process.

Specifically, in some embodiments, the objective function, ^{obj}, may be reduced via iterative mutation of a random initial sequence. Because of the high computational cost of calculating ^{obj}, it may be useful, in some situations, to avoid direct recalculation of the objective function in evaluating each candidate mutation. The reaction pathway engineering system 1901, may exploit two approximations to enable efficient calculation of the objective function estimate, ~^{obj}: using test tube ensemble focusing (e.g., via the test tube ensemble focusing module 1915), sequence optimization initially focuses on only the on-target portion of each test tube ensemble; using hierarchical ensemble decomposition (e.g., via the hierarchical ensemble decomposition module 1920), the structural ensemble of each on-target complex is hierarchically decomposed into a tree of subensembles, yielding a forest of decomposition trees. Candidate sequences may be evaluated at the leaf level of the decomposition forest by the estimations module 1935 by calculating ~^{obj} from nodal defects generated efficiently over the leaf subensembles. As optimized subsequences are merged toward the root level of the forest, any emergent defects may be eliminated via ensemble redecomposition from the parent level on down and sequence reoptimization may be done from the leaf level on up.

After subsequences are successfully merged to the root level, the exact objective function, ~^{obj}, may be calculated (e.g. via the objective function module 1910) for the first time, explicitly checking for the effect of the previously neglected off-target complexes. Any off-target complexes observed to form at appreciable concentration are hierarchically decomposed, added to the decomposition forest, and actively destabilized during subsequent forest reoptimization. When decomposition or focusing defects are encountered, decomposition is performed using multiple exclusive split-points. For sequence initialization, mutation, and reseeding, the reaction pathway engineering system 1901 may solve a constraint satisfaction problem to obtain valid sequences satisfying all constraints in . The elements of this hierarchical sequence optimization process are described herein and in the pseudocode describing an embodiment of the process as included in Appendix I.

### Test Tube Ensemble Focusing

In one embodiment, to reduce the cost of sequence optimization, the set of complexes, Ψ, may be partitioned into two disjoint sets:

Ψ=Ψ^{active}∪Ψ^{passive},

where Ψ_{active} denotes complexes that will be actively designed and Ψ^{passive} denotes complexes that will inherit sequence information from Ψ^{active}. Only the complexes in Ψ^{active} are directly accounted for in the focused test tube ensembles that are used to evaluate candidate sequences. Initially, the reaction pathway engineering system 1901 sets

Ψ^{active}=Ψ^{on},Ψ^{passive}=Ψ^{off} (13)

where
Ψ^{on} ∝∪_{hεΩ}Ψₕ^{on}
is the set of complexes that appear as on-targets in at least one test tube, and

Ψ^{off}∝Ψ\Ψ^{on}

is the set of complexes that appear as off-targets in at least one test tube and do not appear as on-targets in any test tube. Hence, with test tube ensemble focusing, only complexes that are on-targets in at least one test tube are actively designed at the outset of sequence design.

### Hierarchical Ensemble Decomposition

In one scenario, exact evaluation of the objective function, ^{obj}, may require calculation of the test tube ensemble defect contribution, c_{h,j}, for each complex jεΨₕ for each tube hεΩ. The θ(|φⱼ|³)(cost of calculating c_{h,j} is dominated by calculation of the partition function, Qⱼ and equilibrium pair probability matrix, Pⱼ. To reduce the cost of evaluating candidate sequences, the reaction pathway engineering system 1901, and specifically the hierarchical ensemble decomposition module 1920, seeks to estimate c_{h,j} at lower cost by hierarchically decomposing the structural ensemble, ⱼ, of each complex jεΨ^{active} into a binary tree of subensembles, yielding a forest of |Ψₒₙ| decomposition trees. Each node in the forest is indexed by a unique integer k.

In some embodiments, estimating the defect contribution, c_{h,j}, using physical quantities generated at depth d via the estimations module 1935 may include calculation of the nodal partition function, Qₖ, and nodal pair probability matrix, Pₖ, at cost θ(|φₖ|³) for each node k at depth d in the decomposition tree of complex j. For an optimal binary decomposition, |φₖ| halves and the number of nodes doubles at each depth moving down the tree, so the cost of estimating c_{h,j} at depth d can be a factor of ½^{2d-2} lower than the cost of calculating c_{h,j} exactly on the full ensemble Γⱼ. Hence, for maximum efficiency, candidate mutations can be evaluated based on the estimated test tube ensemble defect calculated at the leaves of the decomposition forest. As designed subsequences are merged toward the root level, the test tube ensemble defect is estimated at intermediate depths in the forest.

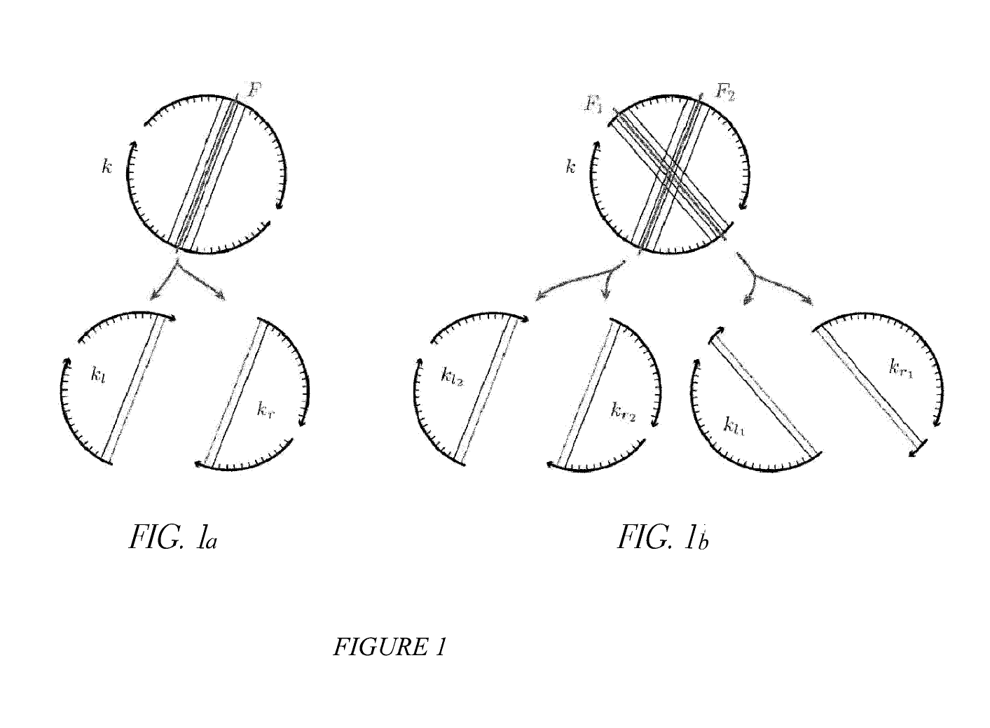

To decompose the structural ensemble Γₖ of parent node k, the nucleotides of k are partitioned by the hierarchical ensemble decomposition module 1920 into left and right child nodes kₗ and kᵣ by a split-point F, as shown in FIG. 1a. In each child ensemble, the base pair adjacent to F can be enforced, leading to conditional child ensembles, \tilde{Γ}ₖ_{ₗ} and \tilde{Γ}ₖ_{ᵣ}, that can be used to reconstruct the conditional parent ensemble, \tilde{Γ}ₖ, which contains all structures in Γₖ that contain the two base pairs that sandwich F. For the purposes of accuracy, it is important that \tilde{Γ}ₖ may include those structures that dominate the equilibrium physical properties of Γₖ, while for the purposes of efficiency, it may be important in some instances that \tilde{Γ}ₖ excludes as many structures as possible that contribute negligibly to the equilibrium physical properties of Γₖ. Hence, the utility of ensemble decomposition may, in one embodiment, depend on suitable placement of the split-point F within parent node k.

The dual goals of accuracy and efficiency can both be achieved by the hierarchical ensemble decomposition module 1920 through placing the split-point F within a duplex that forms with high probability at equilibrium such that approximately half the parent nucleotides are partitioned to each child. Recall that the structural ensemble Γₖ is defined to contain all unpseudoknotted secondary structures, corresponding to precisely those polymer graphs with no crossing base pairs. In one example, since no structure in Γₖ can contain both base pairs that sandwich F and base pairs that cross F, placement of F between base pairs with probability close to one implies that the structures containing base pairs crossing F occur with low probability at equilibrium and may be safely neglected. Partitioning the parent nucleotides into left and right children of equal size minimizes the total cost, θ(|φₖ^{l}|³)+θ(|φₖ^{r}|³) of evaluating both children.

During the course of sequence design, if the base pairs sandwiching split-point F in parent k do not form with probability close to one, the accuracy of the decomposition breaks down. In this case, \tilde{Γ}ₖ excludes structures that are important to the equilibrium physical properties of Γₖ, preventing the children from approximating the full defect of the parent. As described herein, the resulting decomposition defects can be eliminated by redecomposing the parental ensemble, Γₖ, using a set of multiple exclusive split-points, {F}, that define exclusive child subensembles (see FIG. 1b for an example embodiment), again enabling accurate estimation of the parental physical properties.

Structure-Guided Decomposition of on-Target Complexes

In one embodiment, at the outset of sequence design, equilibrium base-pairing probabilities are not yet available to guide ensemble decomposition. Instead, initial decomposition of each on-target complex, jεΨ^{active}, may be guided by the user-specified on-target structure, sⱼ, making the optimistic assumption that the base-pairs in sⱼ will form with probability close to one after sequence design. Using this structure-guided ensemble decomposition approach, as the quality of the sequence design improves, the quality of the ensemble decomposition approximation will also improve.

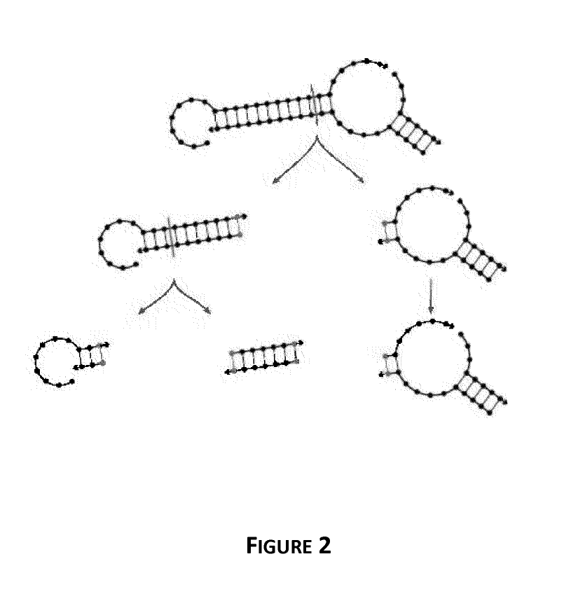

For each complex jεΨ^{active}, the target structure sⱼ can be decomposed by the hierarchical ensemble decomposition module 1920 into a (possibly unbalanced) binary tree of substructures, resulting in a forest of |Ψ^{on}| trees. Each nucleotide in parent structure sₖ is partitioned to either the left or right child substructure (sₖ=sₖ_{ₗ}∪sₖ_{ᵣ}, sₖ_{ₗ}∩sₖ_{ᵣ}=) via decomposition at a split-point F between base pairs within a duplex stem of sₖ. Eligible split-points are those locations within a duplex stem with at least Hₛₚₗᵢₜ consecutive base-pairs on either side, such that each child would have at least Nₛₚₗᵢₜ nucleotides. An eligible split-point is selected so as to minimize the difference in the number of nucleotides in each child, ∥φₖ^{l}|−|φₖ^{r}∥. FIG. 2 includes an example embodiment of a structure-guided hierarchical ensemble decomposition.

In one embodiment, if the maximum depth of a leaf in the forest of binary trees is D, any nodes with depth d<D that lack an eligible split-point may be replicated at each depth down to D so that all leaves have depth D. Let Λ denote the set of all nodes in the forest. Let Λ_{d} denote the set of all nodes at depth d. Let Λ_{d,j} denote the set of all nodes at depth d resulting from decomposition of complex j. Note that each complex jεΨ^{active} contributes a single tree to the decomposition forest whether it is contained in one or more tubes.

FIG. 1 shows an embodiment of an ensemble decomposition of a parent node using one or more split-points sandwiched by base pairs. (a) The single split-point, F, partitions the nucleotides of parent node, k, into left and right child nodes kₗ and kᵣ. (b) The two split-points, F₁ and F₂, cross in the polymer graph (denoted F₁ F₂), and are hence exclusive. Split-points within each parent are depicted in red, sandwiching base pairs within each parent are depicted in black, and base pairs that are enforced within each child ensemble are depicted in green.

FIG. 2 describes an embodiment of a structure-guided hierarchical ensemble decomposition of an on-target complex. Split-points within each parent are depicted in red, sandwiching base pairs within each parent are depicted in blue, and base pairs that are enforced within each child ensemble are depicted in green.

### Stop Condition Stringency

In order to build in a tolerance for a basal level of decomposition defect as subsequences are merged moving up the decomposition forest, the stringency of each test tube stop condition (2) can be increased by a factor of f_{stringent}ε(0,1) at each level moving down the decomposition forest:

f_{h,d}^{stop}∝fₕ^{stop}(f_{stringent})^{d-1}∀dε{1, . . . ,D}.

### Efficient Estimation of Test Tube Ensemble Properties

In some embodiments, the reaction pathway engineering system 1901 may calculate physical quantities at any level dε{2, . . . , D} as described herein to efficiently and accurately estimate the complex contributions, C_{Ψ}^{active}, to the test tube ensemble defect, C. The complex partition function estimates, \tilde{Q}_{Ψ}^{active}, can be constructed from the conditional partition functions, \tilde{Q}_{Λ}_{_{d}}, and the complex pair probability matrix estimates, \tilde{P}_{Ψ}_{_{active}}, can be constructed from the conditional pair probability matrices, \tilde{P}_{Λ}_{_{d}}. For each tube hεΩ, complex concentration estimates, \tilde{x}_{h,Ψ}_{ₕ}_{^{active}}, can then be calculated based on \tilde{Q}_{Ψ}_{ₕ}_{^{active}}, using deflated mass constraints to model the effect of the neglected off-target complexes in Ψₕ^{passive}. Complex ensemble defect estimates, ñ_{Ψ}_{ₒₙ}, can be calculated based on \tilde{P}_{Ψ}_{^{on}}. These estimates can then be used to calculate the defect estimates, \tilde{c}_{h,Ψ}_{ₕ}_{^{on}}, for the complexes in tube h, which are used to calculate the normalized test tube ensemble defect estimate, \tilde{M}ₕ,d for tube h. Finally, these estimates for all tubes hεΩ are used to calculate the objective function estimate, ~_{d}^{obj}.

### Complex Partition Function Estimate

In one embodiment, the estimations module 1935 begins by calculating the complex partition function estimate, \tilde{Q}ⱼ, for each complex jεΨ^{active} in terms of conditional partition functions evaluated efficiently at the nodes kεΛ_{d,j} at any level dε{2, . . . ,D}. Let Eₖ denote the set of base pairs that are enforced in node k, and are hence adjacent to a split-point in some ancestor. On node k, the reaction pathway engineering system 1901 calculates the conditional partition function

\tilde{Q}ₖ∝Q(φₖ|Eₖ) (14)

over the conditional ensemble, \tilde{Γ}ₖ, comprising all structures in Γₖ that contain all base pairs in Eₖ. In one example, this calculation can be performed using a dynamic program suitable for complexes containing arbitrary numbers of strands, enforcing the base pairs in Eₖ by applying a bonus energy, Δ_{G}^{clamp}, each time a base pair in Eₖ is encountered within the dynamic program. It may also be performed using other suitable methods.

Next, the conditional partition functions generated at depth d are merged recursively to estimate the partition function for complex j. Consider split-point Fin parent k, with left-child and right-child conditional partition function, \tilde{Q}ₖ_{ₗ} and \tilde{Q}ₖ_{ᵣ}, and free energy ΔG_{F}^{interior}, for the interior loop formed by the base-pairs sandwiching F. The partition function estimate for parent k is then

\tilde{Q}ₖ=\tilde{Q}ₖ_{ₗ}\tilde{Q}ₖ_{ᵣ}exp(ΔGi_{F}^{interior}/k_{B}T). (15)

At the conclusion of recursive merging, the partition function estimate for complex j based on conditional quantities calculated at depth d is \tilde{Q}ⱼ. This estimate may become exact as the equilibrium probabilities of the base pairs sandwiching decomposition split-points approach unity in accordance with the decomposition assumption. In this case, enforcing these base pairs within the conditional child ensembles at depth d leads to conditional child partition function estimates neglecting only structures that contribute negligibly to the partition function of complex j.

### Complex Pair Probability Matrix Estimate

Similarly, on node k, the estimations module 1935 may calculate the conditional pair probability matrix

\tilde{P}ₖ∝P(φₖ|Eₖ) (16)

over the conditional ensemble, \tilde{Γ}ₖ, using a related dynamic program. The conditional pair probability matrices calculated at depth d may be merged recursively to calculate the pair probability matrix estimate for complex j. During each merge, the matrix entries for the parent are taken from the corresponding entries in the children. At the conclusion of recursive merging, the pair probability matrix estimate for complex j based on conditional quantities calculated at depth d is \tilde{P}ⱼ. This estimate can become exact in the limit as the equilibrium probabilities of the base pairs sandwiching the decomposition split-points approach unity in accordance with the decomposition assumption. In this case, enforcing these base pairs within the conditional child ensembles at depth d is an accurate reflection of the predominant equilibrium base-pairing state of these nucleotides in complex j.

### Calculation of Conditional Partition Functions and Base-Pairing Probabilities

Let Eₖ denote the set of base pairs that are enforced in node k, and are hence adjacent to a split-point in some ancestor. In one embodiment, the estimations module 1935 seeks to calculate the conditional partition function (14):

\tilde{Q}ₖ∝Q(φₖ|Eₖ)

and the conditional equilibrium base-pairing probabilities (16):

\tilde{P}ₖ∝P(φₖ|Eₖ)

over the conditional ensemble, \tilde{Γ}ₖ, comprising those structures in Γₖ that contain all base pairs in Eₖ. The approach in this embodiment is to apply standard dynamic program processes that operate over ensemble Γₖ, but to modify the free energy model so that contributions from structures that do not contain all the base pairs in Eₖ are effectively neglected.

In one example, the partition function may be generated in a forward sweep moving from short subsequences to the full nodal sequence. Equilibrium base-pairing probabilities are then generated in a backward sweep moving from the full nodal sequence back to short subsequences. During the forward sweep, each time a base pair in Eₖ is encountered, the standard free energy is augmented with a bonus energy, ΔG^{clamp}, thus increasing the partition function contribution of every structure containing that base pair by a factor of exp(−ΔG^{clamp}/k_{B}T). By choosing ΔG^{clamp} to be sufficiently negative, contributions from structures lacking any base pair in Eₖ can be effectively neglected. After the forward sweep over ensemble Γₖ using the modified free energy model:
the backward sweep returns conditional pair probabilities P(φₖ|Eₖ) over the conditional ensemble \tilde{Γ}ₖ for the standard free energy model,
the computed partition function value for the full nodal sequence is divided by exp(−|Eₖ|ΔG^{clamp}/k_{B}T) to recover the conditional partition function, Q(φₖ|Eₖ), over the conditional ensemble \tilde{Γ}ₖ for the standard free energy model.

In some embodiments, these processes may be performed using dynamic program processes via general-purpose or specialized processors, memory, etc. suitable for processing complexes containing arbitrary numbers of strands. In some other embodiments, the reaction pathway engineering system 1901 may use other methods to perform these processes.

After calculating the left-child and right-child conditional partition functions, \tilde{Q}ₖ_{ₗ} and \tilde{Q}ₖ_{ᵣ}, the partition function estimate for parent k with split-point F may then (15) be represented as:

\tilde{Q}ₖ=\tilde{Q}ₖ_{ₗ}\tilde{Q}ₖ_{ᵣ}exp(−ΔG_{F}^{interior}/k_{B}T),

where ΔG_{F}^{interior} is the free energy for the interior loop formed by the base-pairs sandwiching F. In each child, the base pair adjacent to F in the parent can be enforced in the child using an energetic bonus as described above. By supposition, this base pair terminates a duplex in every structure in the conditional child ensemble, but borders an interior loop in the conditional parent ensemble. In some embodiments, using nearest neighbor free energy models that include a free energy penalty, ΔG^{terminal}, for terminating a duplex with a non-G·C base pair, if a child has a non-G·C base pair as the terminal clamped pair, the parental partition function can be compensated to remove the penalty present in the child partition function. In some examples, this can be achieved by multiplying the child partition function by a factor of exp(ΔG^{terminal}/k_{B}T) at the time the parental partition function is reconstructed using (15).
Complex Concentration Estimation using Deflated Mass Constraints

In one example, after calculating the set of complex partition function estimates, \tilde{Q}_{Ω}_{^{active}}, based on the conditional partition functions at level d, the equilibrium complex concentration estimates, \tilde{x}_{h,Ψ}_{ₕ}_{^{active}} for tube h may be found by solving the convex programming problem (6). To impose the conservation of mass constraints (6b), the total concentration of each strand species, iεΨₕ⁰ in tube h must be specified. The total strand concentrations

x_{h,i}⁰=Σ_{jεΨ}_{ₕ}_{^{on}}A_{i,j}y_{h,j}∀iεΨh⁰ (17)

follows from the target concentration, y_{h,j}, and strand composition, A_{i,j} of each on-target complex jεΨₕ^{on}.

In one embodiment, using test tube ensemble focusing module 1915, initial sequence optimization can be performed on a decomposition forest that contains only the on-target complexes in Ψ^{active} but ultimately, the reaction pathway engineering system 1901 may try to satisfy the test tube stop condition (2) for each tube hεΩ for the full set of complexes in Ψₕ, including the off-targets in Ψₕ^{passive}. Recall that the off-targets in Ψₕ^{passive} do not contribute directly to the sum used to calculate the test tube ensemble defect (7), but contribute indirectly by forming with positive concentrations, causing concentration defects for complexes in Ψₕ^{active} as a result of conservation of mass. Hence, for each tube hεΩ, the reaction pathway engineering system 1901 can pre-allocate a portion of the permitted test tube ensemble defect, fₕ^{stop}yₕ^{nt}, to the neglected off-target complexes in Ψₕ^{passive} by deflating the total strand concentrations (17) used to impose the mass constraints (6b) in calculating the equilibrium concentrations \tilde{x}_{h,Ψ}_{ₕ}_{^{active}}.

Following this approach if Ψₕ^{passive}≠, the estimations module 1935 makes the assumption that the complexes in Ψₕ^{passive} consume a constant fraction of each total strand concentration:

$${\sum }_{j ∈ {Ψ}_{h}^{passive}} {A}_{i , j} {\tilde{x}}_{h , j} = {f}_{passive} {f}_{h}^{stop} {\sum }_{j ∈ {Ψ}_{h}^{on}} {A}_{i , j} {y}_{h , j} ∀ i ∈ {Ψ}_{h}^{0} ,$$

corresponding to a total mass allocation of fₚₐₛₛᵢᵥₑfₕ^{stop}yₕ^{nt} to the neglected off-targets in Ψₕ^{passive}. To calculate the complex concentration estimates, \tilde{x}_{h,Ψ}_{ₕ}_{^{active}}, via (6), the estimations module 1935 therefore uses the deflated strand concentrations:

$${x}_{h , i}^{0} = ( 1 - {f}_{passive} {f}_{h}^{stop} ) {\sum }_{j ∈ {Ψ}_{h}^{on}} {A}_{i , j} {y}_{h , j} ∀ i ∈ {Ψ}_{h}^{0} \qquad ( 18 )$$

in place of the full strand concentrations (17). In the context of the deflated-mass test tube, the complex concentration estimates, \tilde{x}_{h,Ψ}_{ₕ}_{^{active}}, may become more exact in the limit as the complex partition function estimates, \acute{Q}_{Ψ}_{^{active}}, become exact.

### Complex Ensemble Defect Estimate

In some embodiments, for each complex jεΨ^{on}, the complex ensemble defect estimate, ñⱼ, can be calculated using the complex pair probability matrix estimate, \tilde{P}ⱼ, reconstructed from conditional quantities calculated efficiently at the nodes, kεΛ_{d,j}, at any level dε{2, . . . , D}.

For complex j, the contribution of nucleotide a to the complex ensemble defect estimate is given by:

$${\tilde{n}}_{j}^{a} = 1 - {\sum }_{1 \leq b \leq \vert {φ}_{j} \vert + 1} {\tilde{P}}_{j}^{a , b} {S}_{j}$$

and the complex ensemble defect estimate is then:

$${\tilde{n}}_{j} = {\sum }_{1 \leq a \leq \vert {φ}_{j} \vert} {\tilde{n}}_{j}^{a} .$$

This estimate becomes exact in the limit as the complex pair probability matrix estimate, \tilde{P}ⱼ, becomes exact.

### Test Tube Ensemble Defect Estimate

Having calculated the complex concentration estimates, \tilde{x}_{h,Ψ}_{ₕ}_{^{active}}, and the complex ensemble defect estimates, ñ_{Ψ}_{^{on}}, based on conditional quantities calculated efficiently at any depth dε{2, . . . , D}, the test tube ensemble defect estimate for tube hεΩ can be represented as:

$${\tilde{C}}_{h , d} = {\sum }_{j ∈ {Ψ}_{h}^{on}} {\tilde{c}}_{h , j} , where$$

$${\tilde{c}}_{h , j} = {\tilde{n}}_{j} min ( {\tilde{x}}_{h , j} , {y}_{h , j} ) + \vert {φ}_{j} \vert max ( {y}_{h , j} - {x}_{h , j} , 0 )$$

is the contribution of complex j. The normalized test tube ensemble defect estimate for tube hεΩ at level d can be represented as:

$${\tilde{ℳ}}_{h , d} = {\tilde{C}}_{h , d} \text{/} {y}_{h}^{nt} , where {y}_{h}^{nt} = {\sum }_{j ∈ {Ψ}_{h}^{on}} \vert {φ}_{j} \vert {y}_{h , j}$$

is the total concentration of nucleotides in tube h. In the context of the deflated-mass test tube, this estimate becomes exact in the limit as the concentration estimates, \tilde{x}_{h,Ψ}_{ₕ}_{^{active}} and complex ensemble defect estimates, ñ_{Ψ}_{^{on}}, become exact.

Additionally, the following:

\tilde{M}_{h,d}^{a}=[ñⱼ^{a}min(\tilde{x}_{h,j},y_{h,j})+max(y_{h,j}−\tilde{x}_{h,j},0]/yₕ^{nt}

can represent the contribution of nucleotide a to ~k_{h,d}, which will provide a basis for defect-weighted mutation sampling during leaf mutation and defect-weighted reseeding during leaf reoptimization.

### Multistate Test Tube Ensemble Defect Estimate

The design objective function estimate based on physical quantities calculated efficiently at any depth dε{2, . . . , D}, is then:

$${\tilde{ℳ}}_{d}^{obj} = \frac{1}{\vert Ω \vert} {\sum }_{h ∈ Ω} max ( {\tilde{ℳ}}_{h , d} , {f}_{h , d}^{stop} ) . \qquad ( 19 )$$

### User-Defined Defect Weights

If desired, the user may adjust design priorities by specifying defect weights at three levels of organization within the design problem:
Nucleotide weights: At the nucleotide level, the user can specify mⱼ^{a}ε(0,1] to weight the contribution of nucleotide a to the complex ensemble defect estimate for complex j:

$${\tilde{n}}_{j} = {\sum }_{1 \leq a \leq \vert {φ}_{j} \vert} {w}_{j}^{a} {\tilde{n}}_{j}^{a} .$$

Complex weights: At the complex level, the user can specify w_{h,j}ε(0,1] to weight the contribution of complex j to the normalized test tube ensemble defect estimate in tube h:

$${\tilde{C}}_{h , d} = {\sum }_{j ∈ {Ψ}_{h}^{on}} {w}_{h , j} {\tilde{c}}_{h , j} .$$

Test tube weights: At the test tube level, the user can specify wₕε(0,1] to weight the contribution of test tube h to the design objective function estimate at level d:

$${\tilde{ℳ}}_{d}^{obj} ≡ \frac{1}{\vert Ω \vert} {\sum }_{h ∈ Ω} {w}_{h} max ( {\tilde{ℳ}}_{h , d} , {f}_{h , d}^{stop} ) .$$

By default, all weights are unity. This can be changed as necessary.

### Sequence Optimization at the Leaves of the Decomposition Forest

Initialization

Sequences can be randomly initialized subject to the constraints in by solving a constraint satisfaction problem using a branch and propagate process.

Leaf Mutation

In some embodiments, to minimize computational cost, all candidate mutation sets can be evaluated at the leaf nodes, kεΛ_{D}, of the decomposition forest. Leaf mutation terminates if each tube hεΩ satisfies its leaf stop condition,

~_{h,D}≦f_{h,D}^{stop}. (20)

A candidate mutation set is accepted by the mutations module 1930 if it decreases the objective function estimate (19) and rejected otherwise. Let U denote the set of tubes in Ω that do not yet satisfy a leaf stop condition. The reaction pathway engineering system 1901 performs defect weighted mutation sampling by selecting nucleotide a in tube hε U for mutation with probability,

$$\frac{{\tilde{ℳ}}_{h , d}^{a}}{{\sum }_{h ∈ U} {\tilde{ℳ}}_{h , d}} , \qquad ( 21 )$$

proportional to its contribution to the objective function estimate (19). After selecting a candidate mutation position, a candidate mutation is randomly selected from the set of permitted nucleotides at that position. If the resulting sequence is infeasible (due to constraint violations caused by the candidate mutation), the mutations module 1930 may generate a feasible candidate sequence, \hat{φ}_{Λ}_{_{D}} by solving a constraint satisfaction problem using a branch and propagate process.

A feasible candidate sequence, \hat{φ}_{Λ}_{_{D}} can be evaluated via calculation of the objective function estimate ~_{D}^{obj} if the candidate mutation set, ξ, is not in the set of previously rejected mutation sets, γ_{bad}. The set, γ_{bad}, may be updated after each unsuccessful mutation and cleared after each successful mutation. The counter m_{bad} may be used to keep track of the number of consecutive failed mutation attempts; it is incremented after each unsuccessful mutation and reset to zero after each successful mutation. Leaf mutation terminates unsuccessfully if m_{bad}≧M_{bad}. The outcome of leaf mutation is the feasible sequence, φ_{Λ}_{_{D}}, corresponding to the lowest encountered ~_{D}^{obj}.

Leaf Reoptimization

In one embodiment, after leaf mutation terminates, if a leaf stop condition (20) is not satisfied for any tube hεΩ (i.e., if U≠), leaf reoptimization commences. At the outset of each round of leaf reoptimization, the mutations module 1930 may perform defect-weighted reseeding of M_{reseed} positions by selecting nucleotide a in tube hεU for reseeding (with a new random initial sequence) with probability (21). Following reseeding, a feasible candidate sequence, \hat{φ}_{Λ}_{_{D}}, may be generated by solving a constraint satisfaction problem using a branch and propagate process. After a new round of leaf mutation starting from this reseeded feasible sequence, the reoptimized candidate sequence, \hat{φ}_{Λ}_{_{D}}, may be accepted if it decreases ~_{D}^{obj} and rejected otherwise. The counter mᵣₑₒₚₜ can be used to keep track of the number of rounds of leaf reoptimization; mᵣₑₒₚₜ is incremented after each rejection and reset to zero after each acceptance. Leaf reoptimization terminates successfully if each tube hεΩ satisfies its leaf stop condition (20) and unsuccessfully if mᵣₑₒₚₜ≧Mᵣₑₒₚₜ. The outcome of leaf reoptimization is the feasible sequence, φ_{Λ}_{_{D}}, corresponding to the lowest encountered ~_{D}^{obj}.

Subsequence Merging, Redecomposition, and Reoptimization

In some embodiments, moving down the decomposition forest, hierarchical ensemble decomposition module 1920 makes the assumption that base pairs sandwiching parental split-points form with probability approaching unity. Conditional child ensembles enforce these sandwiching base pairs at all levels in the decomposition forest in accordance with the decomposition assumption. As subsequences are merged moving up the decomposition forest, the accuracy of the decomposition assumption is checked. If the assumption is correct, the child-estimated defect calculated using estimations module 1935 will accurately predict the parent-estimated defect. If the assumption is incorrect, the child-estimated defect will not accurately predict the parent-estimated defect since the conditional child ensembles neglect the contributions of structures that lack the sandwiching base pairs. During subsequence merging, if the decomposition assumption is discovered to be incorrect, hierarchical ensemble redecomposition is performed by module 1920 based on the newly available parental base-pairing information. The details of subsequence merging, redecomposition, and reoptimization are as follows.

After leaf reoptimization terminates, parent nodes at depth d=D−1 may merge their left and right child sequences to create the candidate sequence \hat{φ}_{Λ}_{_{d}}. The parental multistate ensemble defect estimate, ~_{d}^{obj}, can be calculated and the candidate sequence, \hat{φ}^{Λ}_{d}, can be accepted if it decreases ~_{d}^{obj}, and rejected otherwise. If each tube hεΩ satisfies its parental stop condition,

~_{h,d}≦max(f_{h,d}^{stop},~_{h,d+1}/f_{stringent}), (22)

merging continues up to the next level in the forest. Otherwise, failure to satisfy a parental stop condition may indicate the existence of a decomposition defect,

~_{h,d}−~_{h,d+1}/f_{stringent}>0,

exceeding the basal level permitted by the parameter f_{stringent}. Let V denote the set of tubes hεV that do not satisfy a parental stop condition at level d. For each tube hεV, the parent node at depth d whose replacement by its children results in the greatest underestimate of the test tube ensemble defect at level d is subjected to structure- and probability-guided hierarchical ensemble decomposition. In some examples, additional parents can be redecomposed until

~_{h,d}−~_{h,d+1}*/f_{strigent}≦f_{redecomp}(~_{h,d}−~_{h,d+1}/f_{stringent})

is satisfied for all tubes hεV. Here, ~_{h,d+1} is the child defect estimate before any redecomposition, ~_{h,d+1} is the child defect estimate after redecomposition, and f_{redecomp}ε(0,1).

In some embodiments, after redecomposition, the current sequences at depth d can be pushed down to all nodes below depth d and a new round of leaf mutation and leaf reoptimization is performed. Following leaf reoptimization, merging begins again. Subsequence merging and reoptimization terminate successfully if each tube hεΩ satisfies its parental stop condition (22) at depth d=1. The outcome of subsequence merging, redecomposition, and reoptimization is the feasible sequence, φ_{Λ}_{₁}, corresponding to the lowest encountered ~₁^{obj}.

### Test Tube Evaluation, Refocusing, and Reoptimization

Using test tube ensemble focusing module 1915, initial sequence optimization can be performed for the on-target complexes in Ψ^{active}, neglecting the off-target complexes in Ψ^{passive}. At the termination of initial forest optimization, the estimated objective function is estimated objective function is ~₁^{obj}, calculated using (19). For this estimate, each normalized test tube ensemble defect estimate, ~_{h,1}, can be based on complex defect contributions, \tilde{c}_{Ψ}_{ₕ}_{^{active}}, that are in turn based on complex concentration estimates, \tilde{x}_{h,Ψ}_{ₕ}_{^{active}}, calculated using deflated total strand concentrations (18) to create a built-in defect allowance for the effect of the neglected off-targets in Ψhₕ^{passive}. The exact objective function, ^{obj}, can then be evaluated for the first time over the full ensemble Ψ using (3). For this exact calculation, the normalized test tube ensemble defect, ₕ, for each tube hεΩ, is based on complex defect contributions, c_{Ψ}_{ₕ}, that are in turn based on complex concentrations, x_{Ψ}_{ₕ}, calculated using the full strand concentrations (17).

If each test tube hεΩ satisfies its termination stop condition,

ₕ≦max(fₕ^{stop},~_{h,1}), (23)

sequence design terminates successfully. Otherwise, failure to satisfy a termination stop condition may sometimes indicate the existence of a focusing defect,

−~_{h,1}>0. (24)

Let W denote the set of tubes in Ω that do not satisfy a termination stop condition.

For each tube hεW, the test tube ensemble is refocused using test tube ensemble focusing module 1915 by transferring the highest-concentration off-target in Ψₕ^{passive} to Ψₕ^{active}. For each tube hε W, additional off-targets are transferred from Ψₕ^{passive} to Ψₕ^{active} until

ₕ−~_{h,1}*≦f_{refocus}( ₕ−~_{h,1}) (25)

where ~_{h,1} is the forest-estimated defect before any refocusing, ~_{h,1}* is the forest-estimated defect after refocusing (calculated using deflated total strand concentrations (18) if Ψₕ^{passive}≠), and f_{refocus}ε(0,1).

The new off-targets in Ψ^{active} are then decomposed using probability-guided hierarchical ensemble decomposition using module 1920, the decomposition forest is augmented with new nodes at all depths, and forest reoptimization commences starting from the final sequences from the previous round of forest optimization. During forest reoptimization, the process actively attempts to destabilize the off-targets that were added to Ψ^{active}. This process of tube ensemble refocusing and forest reoptimization is repeated until each test tube hεΩ satisfies its termination stop condition (23), which is guaranteed to occur in the event that all off-targets are eventually added to Ψ^{active}. At the conclusion of sequence design, the process returns the feasible sequence set, φ_{Ψ}, that yielded the lowest encountered objective function, ^{obj}.

### Hierarchical Ensemble Decomposition Using Multiple Exclusive Split-Points.

In one embodiment, prior to sequence design, in the absence of base-pairing probability information, hierarchical ensemble decomposition was performed for each complex, jεΨ^{active}, based on the user-specified on-target structure, sⱼ, using the hierarchical ensemble decomposition module 1920. For a parent node, k, with structural ensemble, Γₖ, a single split-point, F, was positioned within a duplex in target structure, sⱼ, so as to minimize the cost of evaluating both children, yielding left and right child nodes kₗ and kᵣ with conditional ensembles \tilde{Γ}ₖ_{ₗ} and \tilde{Γ}ₖ_{ᵣ}. These child ensembles enable reconstruction of the conditional parent ensemble, \tilde{Γ}ₖ, containing all structures in Γₖ, that contain the two base pairs that sandwich F. Following leaf optimization, when left and right child sequences are merged to form a parent sequence, if decomposition defects are observed, \tilde{Γ}ₖ excludes structures that are important to the equilibrium physical properties of Γₖ, implying that the base-pairs sandwiching F do not form with probability approaching unity, and hence that the conditional physical quantities calculated for the children are not sufficient to predict the physical quantities for the parent. This situation is remedied by redecomposing the parent, taking into consideration the newly-available parental base-pairing probabilities.

In some embodiments, two candidate split-points, Fᵢ and Fⱼ, are exclusive if they cross when depicted in a polymer graph (denoted Fᵢ Fⱼ, see FIG. 1b for an example embodiment). The parent ensembles \tilde{Γ}ₖ_{ᵢ} and \tilde{Γ}ₖ_{ⱼ}, reconstructed from the child ensembles implied by exclusive splits points, Fᵢ, and Fⱼ, have no structures in common (\tilde{Γ}ₖ_{ᵢ}∩\tilde{Γ}ₖ_{ⱼ}=). A set of mutually exclusive split-points, {F}, can be used to non-redundantly decompose the parent ensemble using module 1920 so that the sum of the probabilities of the sandwiching base-pair stacks approaches unity from below. During subsequence merging, redecomposition of parent nodes derived from on-target complexes is performed using structure- and probability-guided decomposition using multiple exclusive split-points. During off-target destabilization, decomposition of parent nodes derived from off-target complexes (for which no target structures exist), can be performed using probability-guided decomposition using multiple exclusive split-points. In either case, selection of the optimal set of exclusive split-points is determined using a branch and bound process to minimize the cost of evaluating the child nodes. Because exclusive split-points lead to exclusive structural ensembles, it is straightforward to generalize the expressions used to reconstruct parental physical properties from child physical properties, as detailed below.

### Structure-Guided Decomposition Using a Single Split-Point

For comparison with the formulations that follow, here we recast the previously described structure-guided hierarchical ensemble decomposition using modified notation. Let F denote a split-point and let F^{±} denote the union of the sets of Hₛₚₗᵢₜ base pairs sandwiching F on either side. For a node k descendant from on-target complex jεΨ^{active} with user-specified target structure sⱼ, the nodal target structure matrix, Sₖ, is defined using the corresponding entries from the root target structure matrix Sⱼ. The set of valid split-points may be denoted

$$B ( {S}_{k} ) ≡ \{ F \text{:} \begin{matrix}{min}_{a \cdot b ∈ {F}^{\pm }} {S}_{k}^{a , b} = 1 \\ min ( \vert {φ}_{{k}_{l}} \vert , \vert {φ}_{{k}_{r}} \vert ) \geq {N}_{split}\end{matrix} \} \qquad ( 26 )$$

And the optimal split-point selected for decomposition by the hierarchical ensemble decomposition module 1920,

$${F}^{*} ≡ {min}_{F ∈ B ( {S}_{k} )} ( {\vert {φ}_{{k}_{l}} \vert}^{3} + {\vert {φ}_{{k}_{r}} \vert}^{3} ) ,$$

minimizes the cost of evaluating the two child nodes implied by F.
Probability-Guided Decomposition using Multiple Exclusive Split-Point

In some embodiments, the set of sets of valid exclusive split-points may be denoted

$$\overline{B} ( {P}_{k} ) ≡ \{ \{ F \} \text{:} \begin{matrix}{f}_{split} \leq {\sum }_{{F}_{i} ∈ \{ F \}} {min}_{a \cdot b ∈ {F}_{i}^{\pm }} {P}_{k}^{a , b} \\ {min}_{{F}_{i} ∈ \{ F \}} ( \vert {φ}_{{k}_{{l}_{i}}} \vert , \vert {φ}_{{k}_{{r}_{i}}} \vert ) \geq {N}_{split} \\ {F}_{i} ⊗ {F}_{j} ∀ {F}_{i} \neq {F}_{j} ∈ \{ F \}\end{matrix} \} \qquad ( 27 )$$

for a user-specified value of fₛₚₗᵢₜε(0,1) and the optimal set of exclusive split-points selected for decomposition by the hierarchical ensemble decomposition module 1920,

$${\{ F \}}^{*} ≡ {min}_{\{ F \} ∈ \overline{B} ( {P}_{k} )} {\sum }_{{F}_{i} ∈ \{ F \}} ( {\vert {φ}_{{k}_{{l}_{i}}} \vert}^{3} + {\vert {φ}_{{k}_{{r}_{i}}} \vert}^{2} ) ,$$

minimizes the cost of evaluating the 2|{F}| child nodes implied by {F}.

### Structure- and Probability-Guided Decomposition Using Multiple Exclusive Split-Points

The set of sets of valid split-points may be denoted

$$\hat{B} ( {S}_{k} , {P}_{k} ) ≡ \{ \{ F \} \text{:} \begin{matrix}\{ F \} = {G}_{i} ⋃ {\{ G \}}_{j} , {G}_{i} ∈ B ( {S}_{k} ) , {\{ G \}}_{j} ∈ \overline{B} ( {P}_{k } ) \\ {F}_{i} ⊗ {F}_{j} ∀ {F}_{i} \neq {F}_{j} ∈ \{ F \}\end{matrix} \}$$

And the optimal set of exclusive split-points selected for decomposition by the hierarchical ensemble decomposition module 1920

$${\{ F \}}^{*} ≡ {min}_{\{ F \} ∈ \hat{B} ( {S}_{k} , {P}_{k} )} {\sum }_{{F}_{i} ∈ \{ F \}} ( {\vert {φ}_{{k}_{{l}_{i}}} \vert}^{3} + {\vert {φ}_{{k}_{{r}_{i}}} \vert}^{2} )$$

minimizes the cost of evaluating the 2|{F}| child nodes implied by {F}. In one example, the structure-guided component of this approach may ensure that the redecomposition is compatible with the user-specified target structure, while the probability-guided component of this approach ensures that the physical properties of the parent can be accurately estimated using the children. For any children resulting from split-points that are target-structure-incompatible, subsequent decomposition is performed via probability-guided decomposition using the hierarchical ensemble decomposition module 1920.

### Branch and Bound Process

During probability-guided decomposition, the optimal set of exclusive split points, {F}*, may be chosen to minimize the cost:

$$cost ( \{ F \} ) ≡ {\sum }_{{F}_{i} ∈ \{ F \}} ( {\vert {φ}_{{k}_{{l}_{i}}} \vert}^{3} + {\vert {φ}_{{k}_{{r}_{i}}} \vert}^{3} ) ,$$

subject to constraints (27) on the collective probability:

$$P ( \{ F \} ) ≡ {\sum }_{{F}_{i} ∈ \{ F \}} {min}_{a \cdot b ∈ {F}_{i}^{\pm }} {P}_{k}^{a , b \vert} ,$$

the minimum child size, and split-point exclusivity. The hierarchical ensemble decomposition module 1920 may, in some embodiments, solve this optimization problem using a depth-first branch and bound procedure, where each branch in the optimization tree corresponds to a set of split-points satisfying the exclusivity and child-size constraints. Starting at the root with no split-points, at each branching step, a split-point is added by the hierarchical ensemble decomposition module 1920 so as to greedily maximize the collective probability, P({F}), of the current branch, {F}, while satisfying the exclusivity and child-size constraints. The cost of the current branch, cost({F}), serves as a lower bound on the cost of all unexplored subtrees of this branch. Branching continues until a branch is encountered that satisfies the collective probability constraint, P({F})≧fₛₚₗᵢₜ. This branch defines the current minimal-cost solution, { F̅}, with cost({ F̅}) providing an upper bound on the cost of the optimal split-set. Backtracking commences by removing the final split-point from { F̅} and exploring rival branches by greedily maximizing collective probability. During backtracking, branches are explored only if their cost is less than cost ({ F̅}), otherwise they are trimmed. If an untrimmed branch is encountered that satisfies the collective probability constraint, it becomes the current minimal-cost solution and { F̅} and cost({ F̅}) are updated. After all branches have been trimmed, the current { F̅} is the optimal split set { F̅}*. For structure- and probability-guided decomposition using multiple exclusive split-points as implemented by hierarchical ensemble optimization module 1920, the same approach may be used except that the first branch is selected from B(Sₖ) (26). The computational cost of selecting the optimal set of split-points is typically negligible compared to the cost of evaluating partition functions and equilibrium pair probabilities.

### Test Tube Ensemble Defect Estimation Using Multiple Exclusive Decompositions

In one scenario, the estimations module 1935 may generalize the formulation of test tube ensemble defect estimation at depth dε{2, . . . , D} to account for the possibility of multiple exclusive split-points within any parent in the decomposition forest. Consider parent k decomposed using the set of exclusive split-points, {F}.

Following (15), for each split-point Fᵢε{F}, the corresponding exclusive contribution to the parental partition function estimate is

$${\tilde{Q}}_{{k}_{i}} = {\tilde{Q}}_{{k}_{{l}_{i}}} {\tilde{Q}}_{{k}_{{r}_{i}}} exp ( - Δ {G}_{{F}_{i}}^{interior} / {k}_{B} T ) .$$

yielding the partition function estimate for parent k:

$${\tilde{Q}}_{k} = {\sum }_{{F}_{i} ∈ \{ F \}} {\tilde{Q}}_{{k}_{i}} .$$

Recursive merging is performed until the complex pair probability matrix estimate, \tilde{Q}ⱼ, is obtained.

Likewise, for each split-point Fᵢε{F}, the entries in the exclusive parental pair probability matrix estimate,

$${\tilde{P}}_{{k}_{{l}_{i}}} and {\tilde{P}}_{{k}_{{r}_{i}}} ,$$

Botzmann weighting of exclusive parental estimates then yields the pair probability matrix estimate for parent k:

$${\tilde{P}}_{k} = {\sum }_{{F}_{i} ∈ \{ F \}} {\tilde{P}}_{{k}_{i}} \frac{{\tilde{Q}}_{{k}_{i}}}{{\tilde{Q}}_{k}} .$$

Recursive merging is performed until the complex pair probability matrix estimate, \tilde{P}ⱼ is obtained.

Calculation of the complex ensemble defect estimates, ñ_{Ψ}_{^{on}}, the complex concentration estimates, \tilde{x}_{h,Ψ}_{ₕ}_{^{active}}, and normalized test tube ensemble defect estimate, _{h,d}, for each tube hεΨ, and the objective function estimate, ~_{d}^{obj} may then proceed as before using estimations module 1935.

TABLE 4
IUPAC DEGENERATE NUCLEOTIDE CODES FOR RNA.

| Code | Nucleotides |
|---|---|
| M | A or C |
| R | A or G |
| W | A or U |
| S | C or G |
| Y | C or U |
| K | G or U |
| V | A, C, or G |
| H | A, C, or U |
| D | A, G, or U |
| B | C, G, or U |
| N | A, C, G, or U |

T replaces U for DNA.

### Generation of Feasible Sequences

Each time the sequence is initialized, mutated, or reseeded, a feasible sequence is generated by solving a constraint satisfaction problem based on the user-specified constraints in .

### Constraint Satisfaction Problem

A constraint satisfaction problem (CSP) can be specified as:
a set of variables,
a set of domains, each listing the possible values for the corresponding variable,
a set of constraints, each defined by a constraint relation operating on a subset of the variables.

In the present setting, each variable is the sequence, φ^{a}, of a nucleotide, a. For RNA, the domain for each variable is {A, C, G, U}. Each constraint in is specified using one of the constraint relations in Table 1 applied to one or more nucleotides (e.g., specification of constraint R_{a,b}^{match} requires that φ^{a}=φ^{b} for nucleotides a and b).

In general, constraint satisfaction problems are NP-complete, so general-purpose polynomial-time processes are unavailable. Empirically, we find that CSPs arising in the context of nucleic acid reaction pathway engineering specified in terms of the diverse constraint relations of Table 1 can typically be solved efficiently using the branch and propagate methods described below.

### Branch and Propagate Processes

In some embodiments, the mutations module 1930 solves the CSP using a branch and propagate processes that returns a solution if one exists and returns a warning if no solution exists. Initially, the domain for each variable is {A, C, G, U}. The mutations module 1930 first pre-processes the CSP by trivially removing any value from the domain of a variable a that is inconsistent with a constraint (e.g., an assignment or library constraint). The mutations module 1930 may, in some embodiments, further pre-process the CSP using constraint propagation to impose arc consistency as described below.

The branch and propagate processes involves iterated application of two ingredients:
constraint propagation is used to narrow the search space by imposing arc consistency on each pair of variables: for any value in the domain of variable a there must be a consistent value in the domain of every other variable b, otherwise that value of variable a is inconsistent and can be removed from the domain of a.
depth-first branching is used to extend a candidate partial solution by assigning a consistent value to one additional variable a, followed by backtracking to reassign the value of the most-recently assigned variable if no value in the domain of a is consistent with previous assignments.

### Feasible Sequence Initialization

Sequence initialization commences with constraint propagation to impose arc consistency and then a first branching step in which a variable, a, is randomly selected and randomly assigned a value from the domain of a. Constraint propagation may then be used to impose arc consistency and the next branching step is taken by randomly selecting an unassigned variable, b, and assigning a consistent value from the domain of b. Backtracking is performed if no consistent value for b exists. The branch and propagate processes returns a feasible set of initial sequences, Cactve, if one exists, and a warning otherwise.

### Feasible Sequence Mutation

In one embodiment, during leaf mutation, a feasible candidate sequence can be generated by the mutations module 1930 by mutating the current leaf sequence, φ_{Λ}_{_{D}}. This process may begin with the mutations module randomly selecting a nucleotide a for mutation with probability (21) and randomly assigning a new value from the domain of a. The reaction pathway mutations module 1930 may then solve a CSP to obtain a valid candidate sequence consistent with the new value of a. Constraint propagation is used to impose arc consistency with the new value of a and any variables that require reassignment are added to the candidate mutation set, ξ.

Branching may be performed by the mutations module 1930 by randomly selecting an unassigned variable b from with probability proportional to the size of the domain of b. For each value in the domain of b, the mutations module 1930 may check the implications of arc consistency on the size of the candidate mutation set ξ, and randomly assign a value of b that minimizes the increase in the size of ξ. The branch and propagate process returns a feasible candidate sequence, \hat{φ}_{Λ}_{_{D}}, if one exists. Otherwise, the new value of a is invalid and is removed from the domain of a; a new value of a is randomly selected from the domain of a, and branch and propagate is applied again. If the only valid value of a is the current value, then m_{bad} is incremented and the leaf mutation procedure selects a new nucleotide for mutation with probability (21).

### Feasible Sequence Reseeding

During leaf reoptimization, a feasible candidate reseeded sequence, \hat{φ}_{Λ}_{_{D}}, may be generated by the mutations module 1930 by introducing M_{reseed} feasible sequence mutations to the current leaf sequence, \hat{φ}_{Λ}_{_{D}}, via M_{reseed} consecutive calls to the branch and propagate process (selecting nucleotide a for mutation without replacement during this process).

### Examples

### Implementation

In one example, the constrained multistate sequence design can be coded in programming languages such as the C and C++.

### Sequence Design Trials

For each design problem, 10 independent design trials were performed. Design trials were run on a cluster of 2.53 GHz Intel E5540 Xeon dual-processor/quad-core nodes with 24 GB of memory per node. Other testing environment and testing hardware may also be used. Each trial was run on a single computational core using the default process parameters of Table 5. Design quality is quantified by the multistate test tube ensemble defect divided by the mean stop condition, /fstop; this quantity should be less than or equal to one for a design that achieves the stop condition for each target test tube. Relative design cost is quantified by dividing the cost of sequence design (costdes) by the cost of a single evaluation of the multistate test tube ensemble defect (costeval). To characterize typical design performance for each design problem, we plot sample median over design trials. DNA designs are performed at 25° C. and RNA designs are performed at 37° C. For each design problem, the test tube stop condition was fₕ^{stop}=0.05 for each tube hεΩ (i.e., no more than 5% of the nucleotides in each test tube incorrectly paired at equilibrium).

### Default Parameters for an Embodiment

Default parameters that may be used in one embodiment are shown in Table 5. In other embodiments, different parameters may be used. Note that other parameters and values may be adopted in other embodiments.

TABLE 5
Default parameters for RNA multistate test tube
ensemble defect optimization.

| Parameter | Value |
|---|---|
| fₛₜₒₚ | 0.05 |
| fₚₐₛₛᵢᵥₑ | 0.01 |
| Hₛₚₗᵢₜ | 2 |
| Nₛₚₗᵢₜ | 12 |
| fₛₚₗᵢₜ | 0.99 |
| f_{stringent} | 0.99 |
| ΔG^{clamp} | −25 kcal/mol |
| M_{bad} | 300 |
| M_{reseed} | 50 |
| Mᵣₑₒₚₜ | 3 |
| f_{redecomp} | 0.03 |
| f_{refocus} | 0.03 |

For DNA design, Hₛₚₗᵢₜ = 3.

### RESULTS AND DISCUSSION

### Reaction Pathway Engineering Case Studies

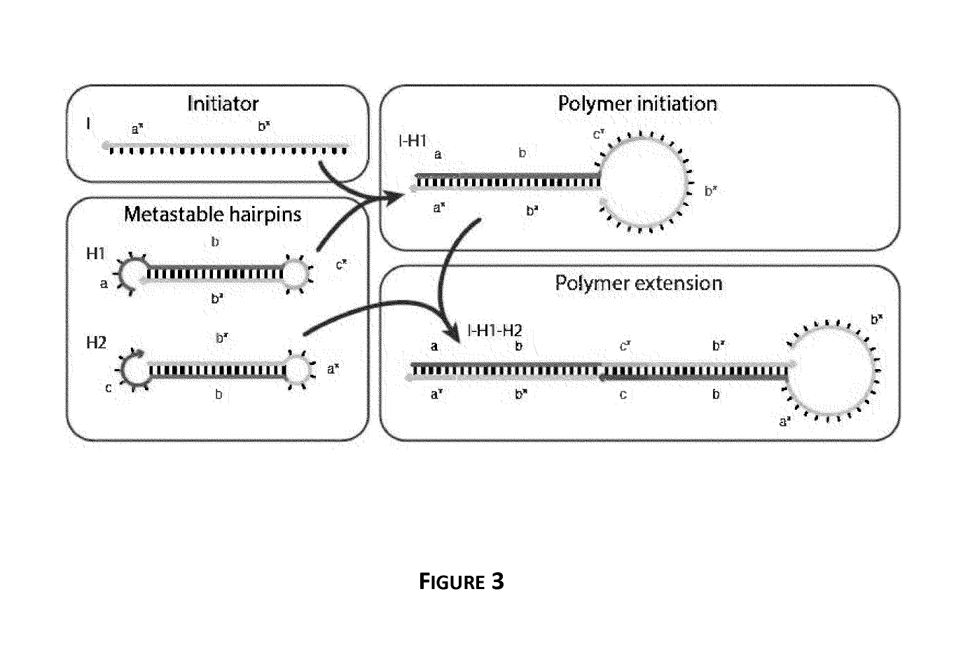

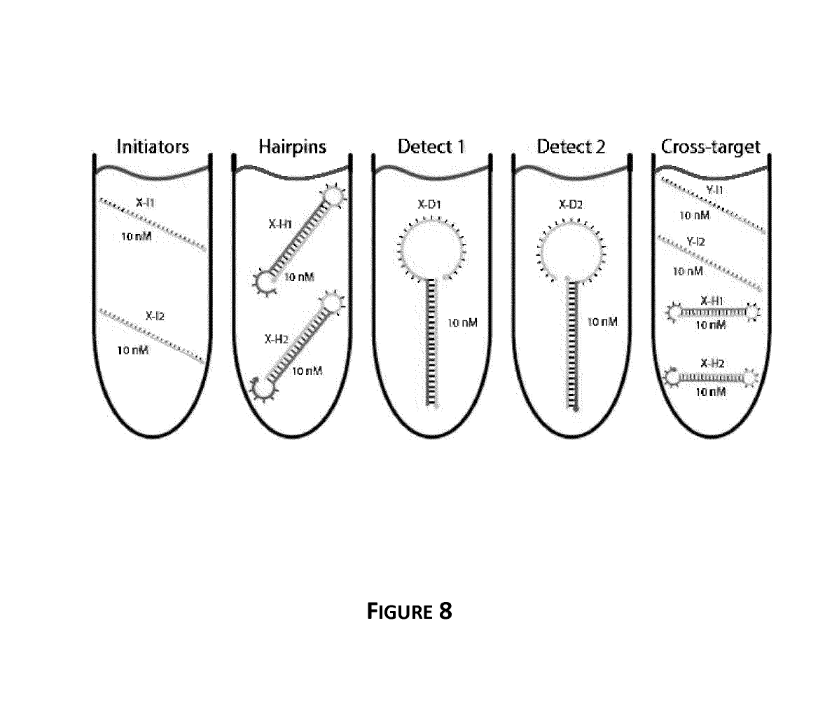

To demonstrate performance, a set of constrained multistate design problems were formulated for selected reaction pathways from the molecular programming literature (Table 6). For each reaction pathway (FIGS. 3-7), we specify a constrained multistate design problem as a set of target test tubes (FIGS. 8-12). For each of the five reaction pathways, we designed one system, as well as 2, 3, 4, or 5 orthogonal systems, leading to a total of 25 design problems. The number of target test tubes |Ω|, on-target complexes |Ψ^{on}|, and off-target complexes |Ψ_{off}| are summarized in Table 6.

TABLE 6
REACTION PATHWAY ENGINEERING CASE STUDIES.

| Reaction | Orthogonal | Tubes | On-targets | Off-targets |
|---|---|---|---|---|
| pathway | designs | \|Ω\| | \|Ψ^{on}\| | \|Ψ^{off}\| |
| conditional self- | 1 | 5 | 6 | 6 |
| assembly via | 2 | 10 | 12 | 20 |
| hybridization chain | 3 | 15 | 18 | 54 |
| reaction (HCR) | 4 | 20 | 24 | 96 |
| | 5 | 25 | 30 | 150 |
| conditional Dicer | 1 | 5 | 6 | 32 |
| substrate formation | 2 | 10 | 12 | 94 |
| | 3 | 15 | 18 | 213 |
| | 4 | 20 | 24 | 406 |
| | 5 | 25 | 30 | 690 |
| Boolean logic AND gate | 1 | 8 | 7 | 58 |
| | 2 | 14 | 14 | 201 |
| | 3 | 20 | 21 | 549 |
| | 4 | 26 | 28 | 1190 |
| | 5 | 32 | 35 | 2180 |
| conditional self-assembly | 1 | 10 | 11 | 41 |
| of a 3-arm junction via | 2 | 20 | 22 | 116 |
| catalytic hairpin | 3 | 30 | 33 | 225 |
| assembly (CHA) | 4 | 40 | 44 | 368 |
| | 5 | 50 | 55 | 545 |
| cooperative hybridization | 1 | 8 | 8 | 95 |
| AND gate | 2 | 16 | 16 | 318 |
| | 3 | 24 | 24 | 846 |
| | 4 | 30 | 32 | 1790 |
| | 5 | 36 | 40 | 3245 |

### Conditional Self-Assembly Via Hybridization Chain Reaction (HCR)

Detection of initiator I triggers a conditional self-assembly cascade in which metastable hairpins sequentially nucleate and open to polymerize into a long nicked double-stranded polymer, as shown in FIG. 3. In the embodiment shown in FIG. 3, an initiator molecule, I, starts a polymerization of hairpins H1 and H2. Initially, I binds to toehold ‘a’ of H1, performs a branch migration to open the hairpin, and exposes sequestered toehold ‘c*’. Subsequently, H2 can bind to the newly exposed region and perform a symmetric addition step. This exposes a tail that is identical to initiator I, allowing this process to repeat. In the absence of I, the hairpins should be metastable and polymerization should be slow.

FIG. 8 shows the target test tubes used to perform sequence design for HCR. The embodiment takes advantage of the periodicity of the addition steps, designing the end of the polymer after each addition step by creating a virtual initiator 12 in addition to the normal initiator I1. The first two tubes, ‘Initiators’ and ‘Hairpins’, optimize against interactions between the two initiators and the two hairpins from the same system, respectively. Tube ‘Detect 1’ optimizes for the binding of hairpin H1 with its initiator I1 to form intermediate D1 with an exposed initiation site for subsequent H2 addition. The H2 addition step is captured in ‘Detect 2’ by including the exposed tail of the previous intermediate, I2, with the second hairpin, H2, which should form the tail of the growing polymer after one more addition, D2. These two steps approximately capture the energetics of each subsequent addition. The final tube type, ‘Cross-target’, optimizes against off-target binding and activation. Each set of hairpins is designed in the context of all off-target initiators, designing against all possible dimers. This optimizes against initiators from independent systems binding to each other as well against HCR initiation by an off-target initiator.

### Conditional Dicer Substrate Formation

Upon binding mRNA detection target containing subsequence ‘a-b-c’, scRNAs perform shape and sequence transduction to produce a Dicer substrate targeting an mRNA silencing target containing independent subsequence ‘x-y-z’, as shown in FIG. 4. In the embodiment shown in FIG. 4, a sequence from an mRNA conditionally produces a substrate for the Dicer enzyme that targets an independent mRNA sequence. Starting with a short window from the target mRNA, Xs, input A·B binds, producing waste dimer Xs·A and single-stranded molecule B. This molecule is then free to perform loop invasion and branch migration on molecule C, producing Dicer substrate B·C.

FIG. 9 shows the target test tubes used to perform sequence design for conditional Dicer substrate formation. The reactant dimer and hairpin are designed to be stable when mixed in a dilute solution, even at a concentration of 100 nM. The two steps of the reaction are captured using the tubes ‘Step 1’ and ‘Step 2’. The ‘Step 1’ tube optimizes the first step of the reaction: binding of A·B to input window Xs to form intermediate B and waste Xs·A. The Step 2 optimizes B binding to hairpin C, forming dimer B·C. This dimer is an RNA duplex that can be processed by Dicer, silencing the knockout target gene. The ‘Inactive’ tube designs against unintended interactions between C and the input window Xs. The ‘Cross-target’ tube designs against off-target interactions between orthogonal systems. For this embodiment, most nucleotides are constrained to be subsequences of either a detection target or a silencing target. The sequence of Xs may be constrained to be a subsequence of the input target mRNA, eGFP, using a window sequence constraint. The sequence of the first 19 nucleotides of the duplex B·C was similarly constrained to be a subsequence of the silencing mRNA target, dsRed2, using another window sequence constraint. These constraints reduce the number of feasible sequences for the design by over ten orders of magnitude compared to the unconstrained design problem. Each tube contains all off-targets containing up to Lₘₐₓ=3 strands.

### Boolean Logic AND Gate

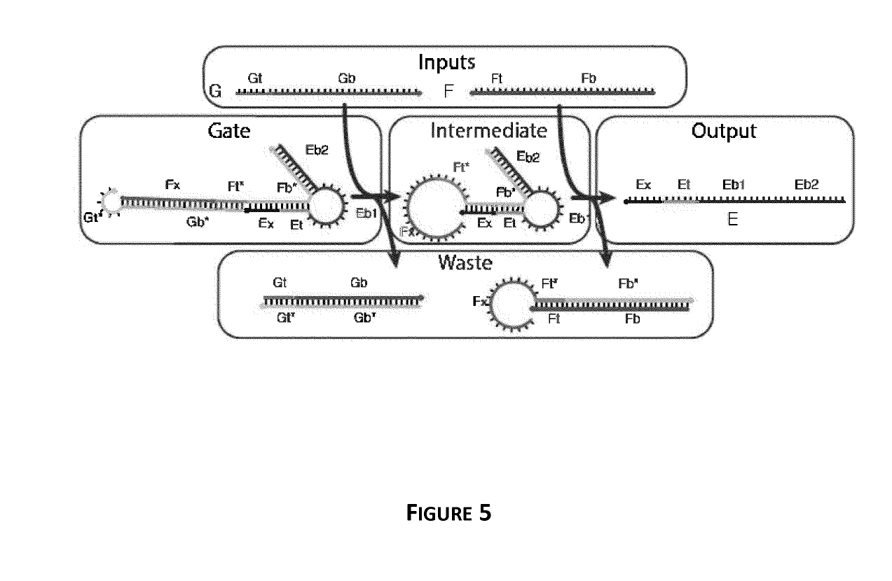

Detection of input sequences F and G leads to release of output sequence E, as shown in FIG. 5. In the embodiment shown in FIG. 5, the gate reacts with inputs G and F via toehold-mediated strand displacement to produce output E and two waste molecules. Input G binds to the gate via domain Gt and performs a branch migration, simultaneously creating the first waste duplex while exposing toehold Ft. Input F binds to the newly exposed toehold and performs a second branch migration across domain Fb, producing a waste duplex and releasing output molecule E.

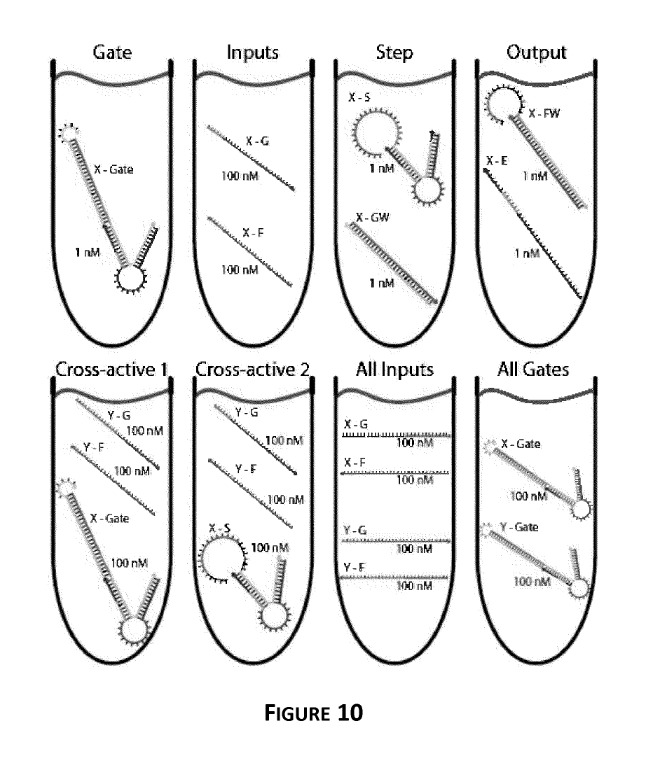

FIG. 10 shows the target test tubes used to perform sequence design for Boolean logic AND gates. The 3-stranded gate molecule is designed in isolation and the two input strands are designed together to be unstructured. The first step and output step are optimized in independent tubes. Cross-activation is captured in two sets of tubes; the ‘Cross-active’ tubes prevent inputs from binding to the wrong gate molecule, and the ‘All Inputs’ and ‘All Gates’ tubes prevent binding between independent input and gate molecules. Note that each tube that primarily optimizes a multi-stranded on-target complex (‘Gate’, ‘Step’ and ‘Output’ tubes) contains all species at a low concentration, 1 nM, to enforce high affinity. The remaining tubes design primarily against unintended binding. These contain all species at a higher concentration, 100 nM, to stringently avoid cross-talk.

In FIG. 10, the first two tubes, ‘Gate’ and ‘Inputs’ capture desired initial states, optimizing against input strand dimerization and towards formation of the AND gate trimer. The ‘Step’ tube optimizes the first step of the reaction (after adding input strand G). The ‘Output’ tube optimizes for correct output production after adding the second input strand. The ‘Cross-active 1’ tube designs against interaction between the gate complex from one system, X, and the inputs from all other systems, Y. The ‘Cross-active 2’ tube designs against interactions between the intermediate complex from one system, X, and the inputs from all other systems, Y. In both of the ‘Cross-active’ tubes, all off-target input strands are included in the same tube as the gate or intermediate. For the design of three orthogonal AND gate systems, for instance, there would be three Cross-active 1 tubes, each tube would include a single AND gate and four off-target input strands. The ‘All Inputs’ and ‘All Gates’ tubes include all input strands and all gates in the same dilute solution, designing against unintended binding of input strands and crosstalk between gate complexes. The ‘Gate’, ‘Step’, ‘Output’, ‘Cross-active 1’, and ‘Cross-active 2’ tubes contain all off-targets containing up to Lₘₐₓ=3 strands. The remaining tubes contain all off-targets containing up to Lₘₐₓ=2 strands.

### Conditional Self-Assembly of a 3-Arm Junction Via Catalytic Hairpin Assembly (CHA)

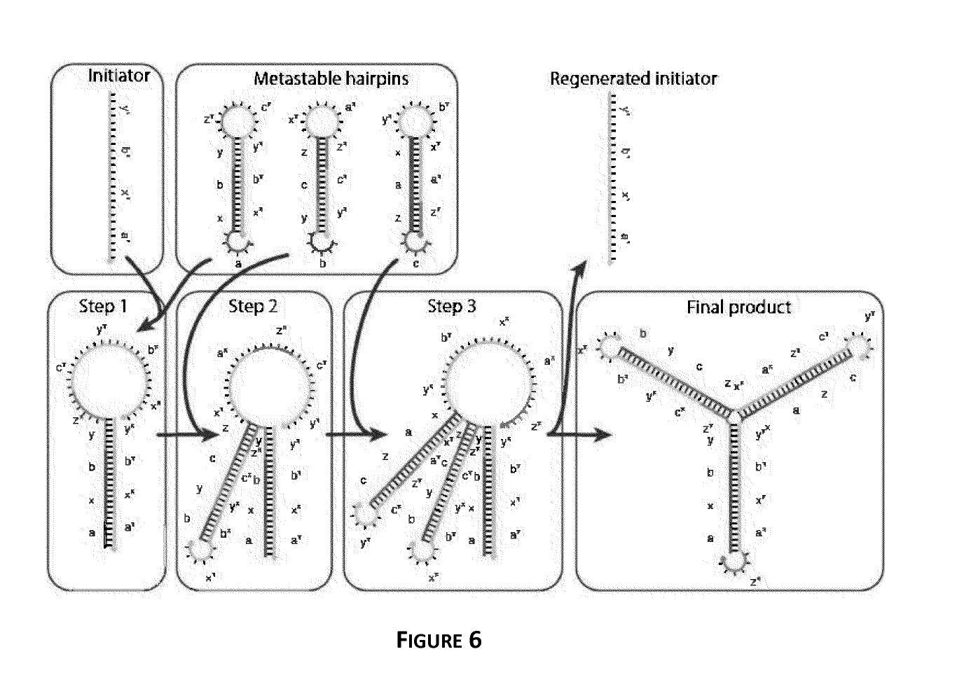

Upon detection of Initiator, metastable hairpins undergo conditional catalytic self-assembly to form a 3-arm branched junction, as shown in FIG. 6. In the embodiment in FIG. 6, an initiator molecule catalyzes the formation of three-arm junctions. Starting with the unstructured initiator, each hairpin adds to the free end of the complex, performs a branch migration, and exposes a new unstructured tail. After the third hairpin is added, the initiator, which is identical to the first four domains of the now-free tail of the third hairpin, is regenerated via a final branch-migration step. In some other embodiments, a method other than branch-migration may also be implemented.

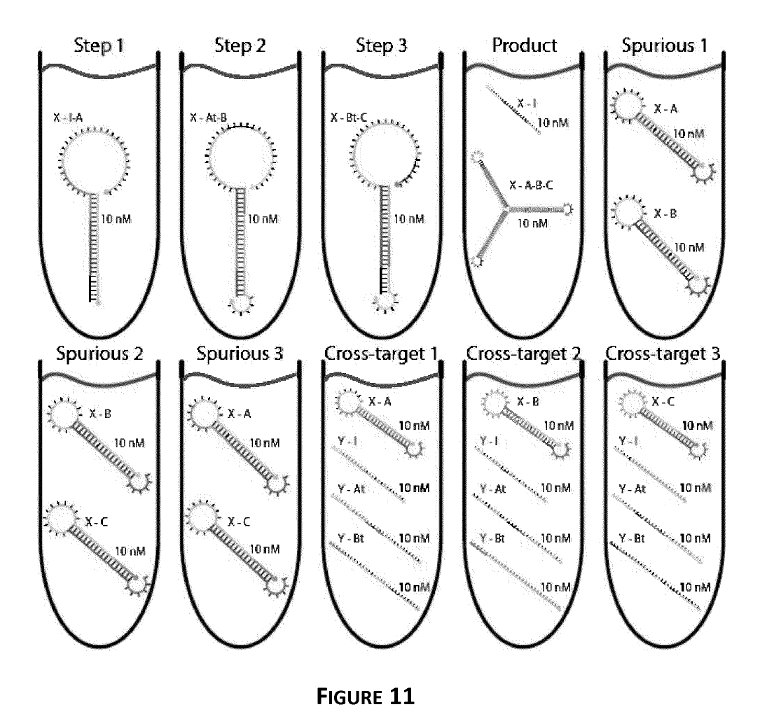

FIG. 11 shows the target test tubes used to perform sequence design for conditional self-assembly of 3-arm junctions via CHA. The three hairpin binding steps are captured in independent ‘Step’ tubes, capturing the same symmetry as in the HCR designs. The final product is designed in a separate ‘Product’ tube. Each pairwise dimerization of hairpins is designed against in the ‘Spurious’ tubes. The ‘Cross-target’ tubes design against dimerization of any off-target input or intermediate hairpin tail with the each hairpin.

In FIG. 11, this embodiment takes advantage of the pattern of the three addition steps, including only the exposed tail of the previous hairpin in each addition step. The first three tubes, ‘Step 1’, ‘Step 2’, and ‘Step 3’, represent the three hairpin additions. Product formation is optimized in the ‘Product’ tube. ‘Spurious 1’, ‘Spurious 2’, and ‘Spurious 3’ optimize against all pairwise dimerizations between the hairpins. We cannot directly optimize against the three-arm junction forming since the mechanism is metastable; if the ‘Product” tube forms correctly, the stable state of the three hairpins in solution will be the three-arm junction. Each ‘Cross-target’ tube optimizes against binding of the hairpin from one system, X, to the input strands and exposed tails of intermediates from the remaining systems, Y. For example, in the design of three orthogonal three-arm junction assembly instantiations, there are three tubes of the type Cross-target 1. Each of these tubes contains seven on-targets, one hairpin and six single-stranded molecules, representing the input catalyst strand and exposed tails of hairpins from each of the other two systems. Each tube contains off-targets with up to Lₘₐₓ=2 strands except the ‘Product’ tube, which contains all off-targets with up Lₘₐₓ=3 strands.

### Cooperative Hybridization AND Gate

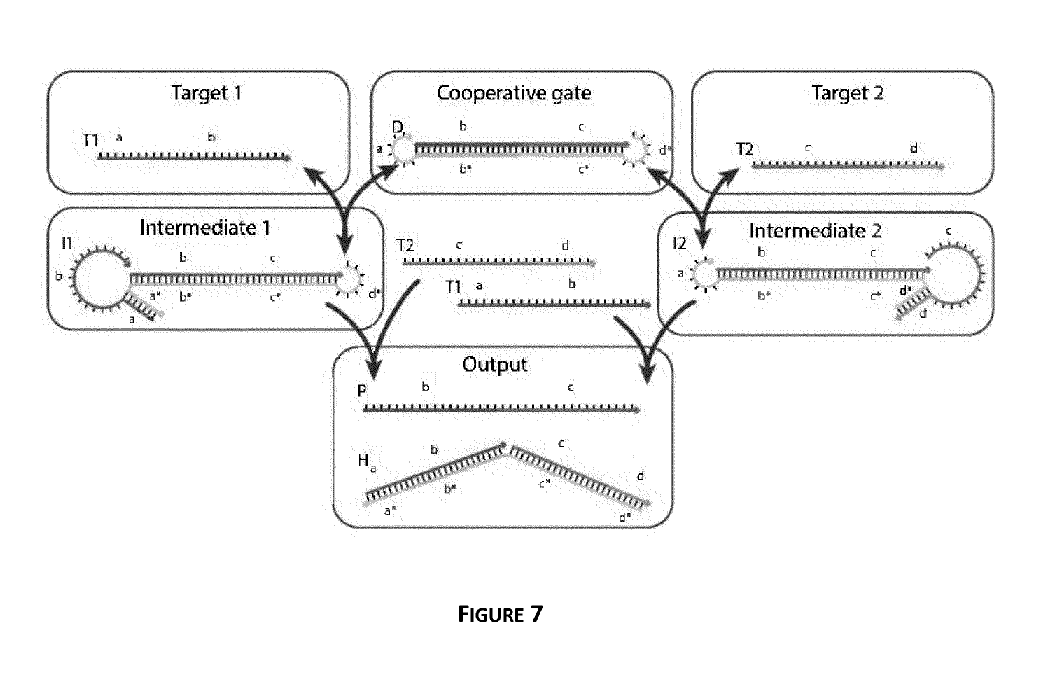

FIG. 7 depicts an embodiment wherein two input sequences T1 and T2 cooperatively displace output sequence P. As shown in the embodiment in FIG. 7, two input molecules, T1 and T2, may cooperatively bind to gate D to displace output strand P. Starting with gate D, T1 can bind to toehold ‘a*’ or T2 can bind to toehold ‘d*’. In the absence of the other input, any branch migration will be unproductive since many base pairs will remain between the two gate strands, and the input will eventually dissociate. When both inputs bind to the same molecule, however, they can both branch migrate and cooperatively release output P.

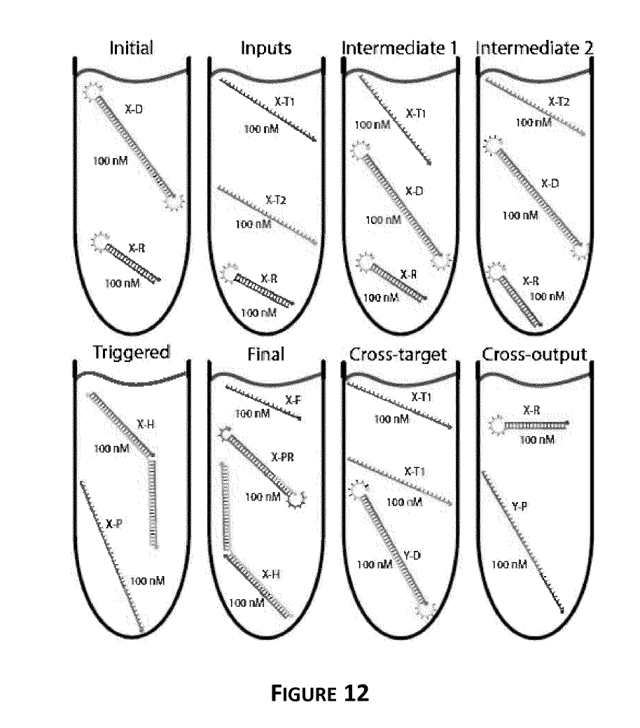

FIG. 12 shows the target test tubes used to perform sequence design for cooperative hybridization AND gates. Each input gate is optimized to form along with the downstream reporter even in the presence of one or the other input. The inputs are designed to avoid interaction with each other. When both are present along with gate D, they should displace strand P, which releases the fluorophore-labeled F from the reporter gate, if present. The ‘Cross-target’ tube optimizes against interaction of the inputs T1 and T2 from one system with the input strands, gates, and reporter gates from other systems. The ‘Cross-output’ tube optimizes against intermediate strand P from one system interacting with reporter gate R from another system. This design problem in this embodiment balances the strength of toehold binding: binding must be strong enough to drive the reaction at experimental concentrations when both inputs are present, but weak enough to avoid persistent binding of either input to the gate in the absence of the other input.

Specifically, as shown in FIG. 12, the first two tubes capture the desired initial states, optimizing against premature activation of the reporter RF (tube ‘Initial’) and against any dimerization of the input strands (tube ‘Inputs’). The tubes ‘Intermediate 1’ and ‘Intermediate 2’ optimize against activation of the gate when only one input is present. The ‘Triggered’ tube is representative of the state of the tube with both inputs but without the reporter, the intermediate output P is released. The ‘Final’ tube is representative of the final state of the gate when both inputs are present, and the final output F is released. The ‘Cross-target’ tube optimizes against cross-talk between the gate from one system, X, and the input strands from all other systems Y. The ‘Cross-output’ tube optimizes against cross-talk between the reporter from one system, X, and all possible intermediate outputs from the other systems Y. In this embodiment, each tube contains all off-targets containing up to Lₘₐₓ=3 strands.

### Performance

One to five orthogonal systems were designed for each of five reaction pathways with the stop condition set to 5% for each target test tube (fₕ^{stop} ∀hεΩ). Ten design trials were run for each of these 25 design problems.

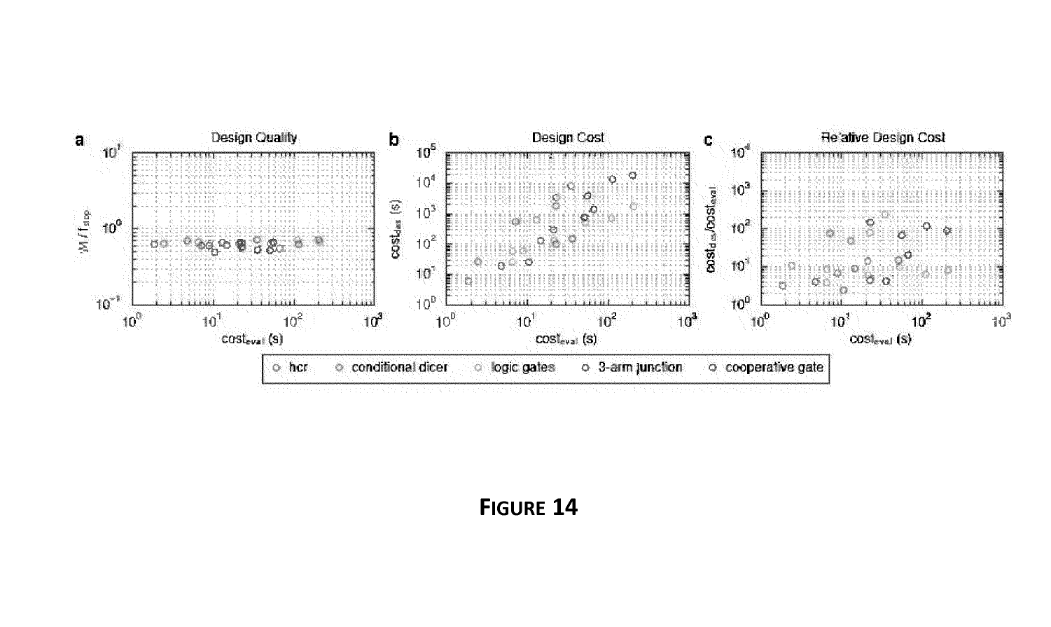

To characterize typical performance for each design problem, we plot the median over 10 design trials for design quality, design cost, and relative design cost in FIG. 14. Design quality is quantified by the multistate test tube ensemble defect divided by the mean stop condition, /fₛₜₒₚ; this quantity should be less than or equal to one for a design that achieves the stop condition for each target test tube. Designs typically achieve the stop condition (panel a). Notably, the reaction pathway engineering system 1901 succeeds in generating five orthogonal designs for conditional Dicer substrate production even though window sequence constraints imposed sequence identity with subsequences from the same two target mRNAs for each instantiation. The design cost and evaluation cost both increase with problem size (panels b and c). The design cost relative to the cost of evaluating the multistate test tube ensemble defect sometimes remains the same, but sometimes increases (panel c). The logic gates and cooperative gates show nearly constant relative costs. Designs for HCR, conditional Dicer substrate formation, and catalytic 3-arm junction formation all show an increase in relative design cost as the number of orthogonal systems is increased.

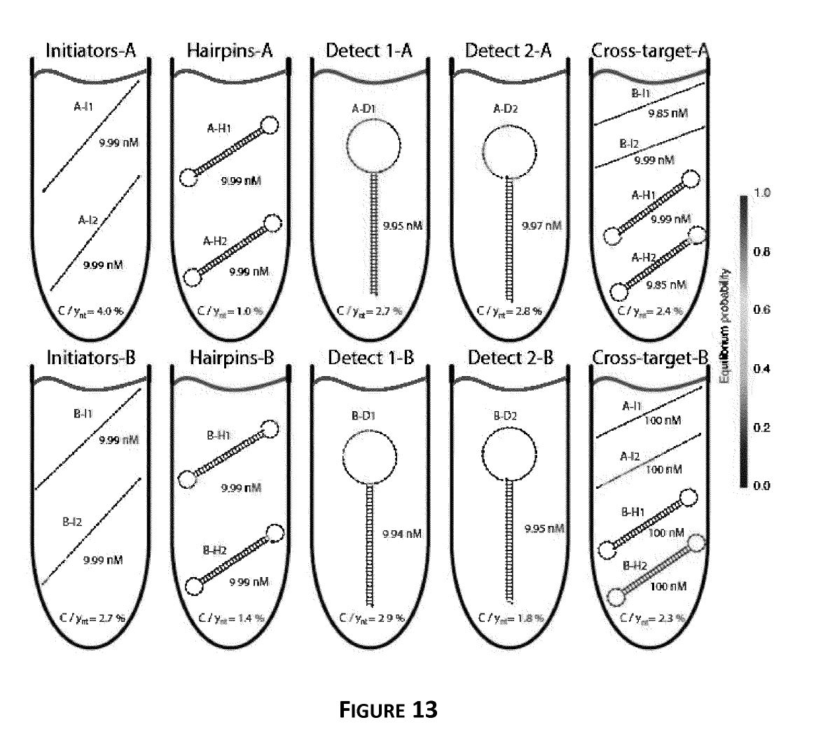

An example result for the design of two orthogonal HCR systems is depicted in FIG. 13. The stop condition was achieved for every target test tube. Comparing this with the HCR target test tubes in FIG. 8, we can see that the concentrations are similar to the target concentrations. Each tube is dominated by the on-target complexes and each structural ensemble is dominated by its target structure. As shown in this embodiment, the first row of tubes corresponds to the specification for the first HCR system, and the second row of tubes corresponds to the second system. The ‘Cross-target’ tubes minimize cross-talk between the two systems. The normalized test tube ensemble defect for each tube is shown at the bottom of the tube.

### Preventing Sequence Patterns

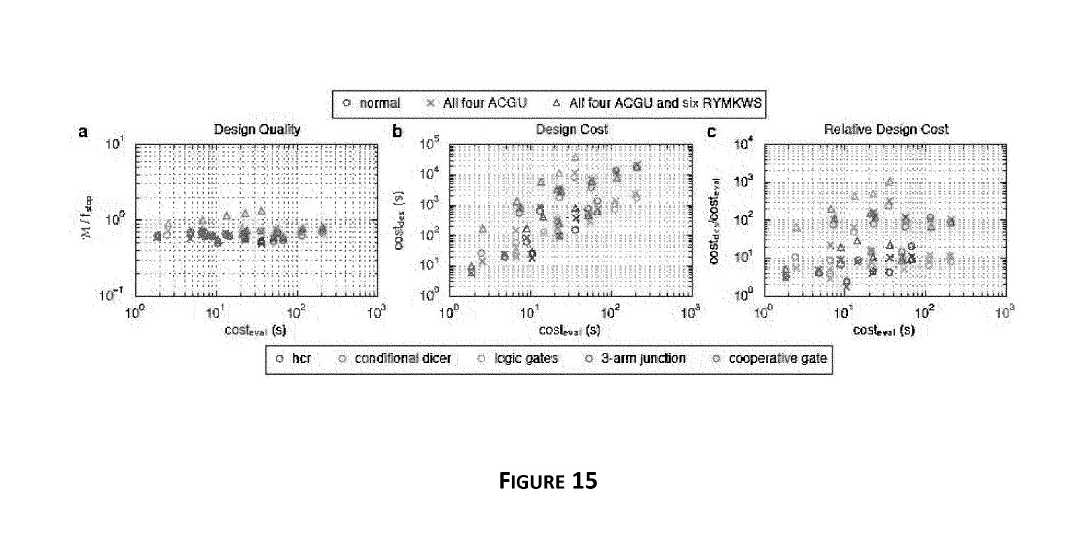

Adding pattern prevention constraints (RP^{pattern} of Table 1) keeps particular subsequences from appearing in a specified strand or set of strands. For example, we can prevent any nucleotide from showing up in four positions in a row by preventing the patterns AAAA, CCCC, GGGG, UUUU, or we could prevent any pair of nucleotides from appearing in six consecutive positions by preventing the patterns RRRRRR, YYYYYY, MMMMMM, KKKKKK, WWWWWW, SSSSSS. The design performance while preventing four consecutive instances of the same nucleotide or both four consecutive of the same nucleotide and six consecutive of any two nucleotides are shown in FIG. 15 along with the original design performance. Preventing any repeats of a single nucleotide four times in a row does not have substantial effect on design quality or cost. Preventing a single nucleotide from appearing four consecutive times and any pair of nucleotides six consecutive times, has an effect on two of the designs. The cost of design for conditional Dicer systems increases by nearly an order of magnitude when these constraints are used and the cost of HCR systems increases by a factor of one to two when these constraints are included. Remarkably, the conditional Dicer designs nearly satisfy their stop conditions even under these additional constraints. The remaining design types do not show a large effect on design quality or cost when these constraints are included.

### Constraining Content

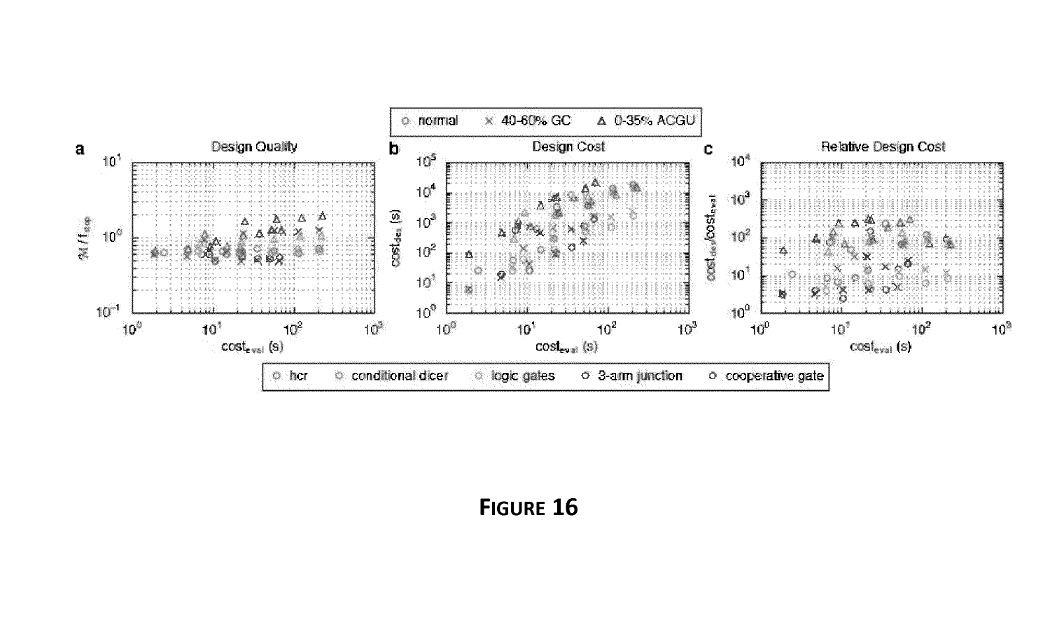

Composition constraints can be used to specify sequence composition and similarity constraints can be used to specify similarity to a sequence of choice (R^{composition} and R^{similarity} of Table 1). We demonstrate these capabilities by creating a set of designs that are constrained to have a GC content between 40% and 60% for every sequence domain. We created another set of designs where no nucleotide type could make up more than 35% of any domain longer than 3-nt. The effects of these sequence constraints on the quality and cost of design are shown in FIG. 16. The multistate test tube ensemble defect and design cost both increase under these constraints. Under the GC content constraint, the cooperative gates typically fail to satisfy their stop condition. The ensemble defect shows deterioration of design quality when no nucleotide is allowed to constitute more than 35% of any domain. In several cases, the design cost increases by over an order of magnitude using this set of constraints. Note that the conditional Dicer designs cannot satisfy the constraints. Instead, these designs correctly warn that the constraints cannot be satisfied they permit no feasible sequences.

### Weighting Structural Defects

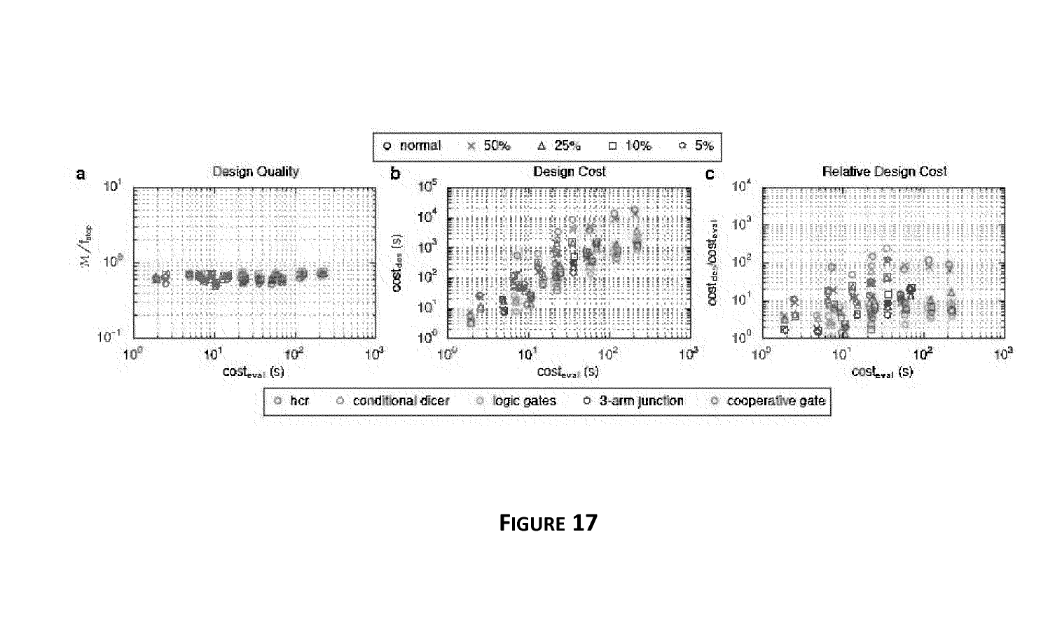

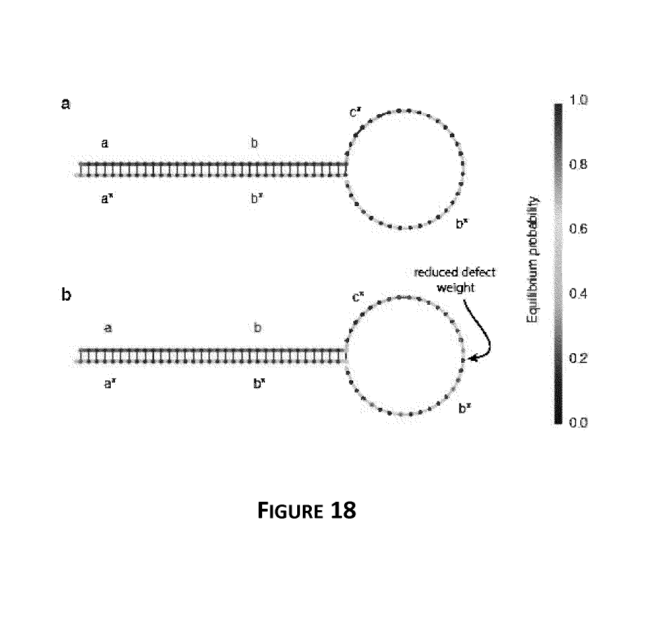

FIG. 17 shows the performance of the test tube design process when using structural defect weighting. All single-stranded regions except toeholds were assigned a reduced weight wⱼ^{al}ε{0.05, 0.10, 0.25, 0.50}. Reducing the weight of the structural defects from unity makes the stop condition less stringent and so typically results in lower design cost and satisfaction of more stop conditions. The effect of using structural weights is shown in FIG. 18 for the ‘Detect 1’ target structure from a designed HCR system. Panel a shows the target structure when the default weights of 1.0 are used everywhere. Panel b shows the target structure designed with nucleotide defect weights of 0.25 in the single-stranded ‘b*’ domain. The design with all weights equal to unity shows reduced base-pairing in the exposed ‘b*’ domain, while the structure with reduced weights maintains low nucleotide defects in the duplex stem and in the toehold ‘c*’, but allows some pairing in the exposed ‘b*’ domain.

### CONCLUSION

In some embodiments, constrained multistate test tube design provides a powerful framework for nucleic acid reaction pathway engineering. As discussed above, sequence design may be formulated as a multistate optimization problem using a set of target virtual test tubes containing different subsets of the strands to represent reactant, intermediate, and product states of the reaction pathway. Each target test tube contains a set of desired ‘on-target’ complexes, each with a target secondary structure and target concentration, and a set of undesired ‘off-target complexes’, each with vanishing target concentration. In one embodiment, the multistate test tube ensemble defect provides a physically meaningful basis for quantifying sequence quality over the set of target test tubes using the objective function module 1910. Sequence design may be performed using the mutations module 1930 subject to both implicit sequence constraints inherent to the reaction pathway and explicit sequence constraints imposed by the user, including compatibility with prescribed biological sequences. In one embodiment, constrained multistate test tube ensemble defect optimization using the reaction pathway engineering system 1901 implements positive and negative design paradigms at three levels: (1) explicitly designing for the target structure and against all off-target structures within the ensemble of each complex, (2) explicitly designing for the target concentration of all on-target complexes and against the formation of all off-target complexes within the ensemble of each test tube, (3) explicitly designing for on-pathway states and against off-pathway states along the reaction pathway.

The reaction pathway engineering system 1901 may, in some examples, implement three concepts, among others, that enable efficient multistate test tube design by reducing the cost of evaluating candidate sequences:
Test tube ensemble focusing: Test tube ensemble focusing with test tube ensemble focusing module 1915 dramatically reduces the number of complexes that are actively considered within the ensemble of each test tube during sequence optimization. Initially, only on-target complexes are included in the focused ensemble, making the assumption that all off-target complexes will form with negligible concentration at equilibrium and may be neglected. If this assumption proves incorrect, test tube ensemble refocusing is performed to ensure that any off-target complexes observed to form with non-negligible concentration in a full test tube ensemble are included in the focused ensemble for active destabilization during subsequent rounds of sequence optimization.
Hierarchical ensemble decomposition: Hierarchical ensemble decomposition with the hierarchical ensemble decomposition module 1920 dramatically reduces the number of structures that are actively considered within the ensemble of each complex during sequence optimization. The structural ensemble of each complex in a focused test tube ensemble is decomposed into a tree of conditional sub-ensembles, yielding a forest of decomposition trees. Decomposition of each parent ensemble makes the assumption that many off-target structures will form with negligible probability at equilibrium and may be neglected in the conditional child ensembles that are used to efficiently estimate physical properties of the parent. If this assumption proves incorrect, hierarchical ensemble redecomposition is performed to ensure that any off-target structures observed to form with non-negligible probability in the parent ensemble are included in the conditional child ensembles for active destabilization during subsequent rounds of sequence optimization.
Generation of conditional physical properties: By calculating conditional partition functions and conditional pair probabilities over the conditional structural ensembles at the leaves of the decomposition forest using the estimations module 1935, the equilibrium base-pairing properties of a test tube of interacting strands can be accurately and efficiently estimated. This estimation capability applies to the multistate test tube ensemble defect that provides a physically meaningful basis for test tube design, as well as to other underlying physical quantities (complex partition functions, complex pair probabilities, and complex concentrations) that may be of interest in other contexts.

Other techniques may be used in combination with these methods.

Used in combination in some embodiments, test tube ensemble focusing, hierarchical ensemble decomposition, and calculation of conditional physical properties enable the reaction pathway engineering system 1901 to efficiently estimate and optimize the multistate test tube ensemble defect. Generation of feasible candidate sequences by efficient solution of a constraint satisfaction problem enables sequence design even in presence of stringent user-specified sequence constraints. Constrained multi-state sequence design facilitates nucleic acid reaction pathway engineering for diverse applications in molecular programming and synthetic biology.

### DEFINITIONS

As used herein, an “input device” can be, for example, a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

Embodiments of the invention are operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices.

As used herein, “instructions” refer to computer-implemented steps for processing information in the system. Instructions can be implemented in software, firmware or hardware and include any type of programmed step undertaken by components of the system.

A “microprocessor” or “processor” may be any conventional general purpose single- or multi-core microprocessor such as a Pentium® processor, Intel® Core™, a 8051 processor, a MIPS® processor, or an ALPHA® processor. In addition, the microprocessor may be any conventional special purpose microprocessor such as a digital signal processor or a graphics processor.

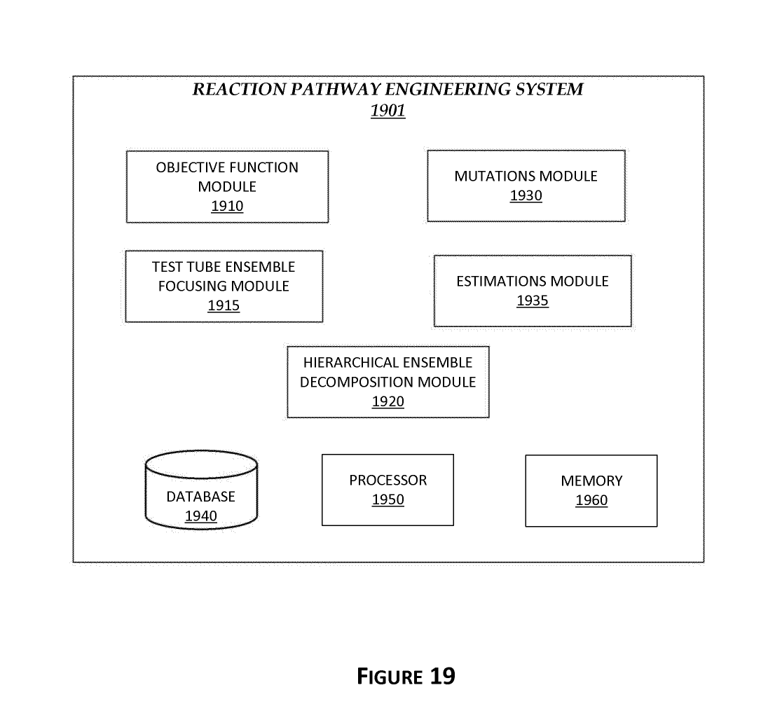

The reaction pathway engineering system 1901 is comprised of various modules as discussed in detail herein and in FIG. 19. As shown in FIG. 19, the reaction pathway engineering system 1901 includes an objective function module 1910, a test tube ensemble focusing module 1915, a hierarchical ensemble decomposition module 1920, a mutations module 1930, and an estimations module 1935. It also includes a processor 1950 and a memory 1960. It may also include a database 1940 in some embodiments. The objective function module 1910 calculates the multistate test tube ensemble defect and the design objective function. The test tube ensemble focusing module 1915 initially focuses design effort on the on-target portion of each test tube ensemble. The hierarchical ensemble decomposition module 1920 can be configured to decompose each focused test tube ensemble into a decomposition forest of subensembles. The mutations module 1930 generates feasible candidate sequences based on diverse sequence constraints. The estimations module 1935 estimates the design objective function for a feasible candidate sequence at any level in the decomposition forest.

As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The reaction pathway engineering system 1901 system may be used in connection with various operating systems such as SNOW LEOPARD®, iOS®, LINUX, UNIX or MICROSOFT WINDOWS®.

The reaction pathway engineering system 1901 may be written in any conventional programming language such as C, C++, BASIC, Pascal, or Java, and run under a conventional operating system.

A web browser comprising a web browser user interface may be used to display information (such as textual and graphical information) to a user. The web browser may comprise any type of visual display capable of displaying information received via a network. Examples of web browsers include Microsoft's Internet Explorer browser, Mozilla's Firefox browser, Apple Safari and PalmSource's Web Browser, or any other browsing or other application software capable of communicating with a network.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

In addition, the modules or instructions may be stored onto one or more programmable storage devices, such as FLASH drives, CD-ROMs, hard disks, and DVDs. One embodiment includes a programmable storage device having instructions stored thereon that when executed perform the methods described herein to determine nucleic acid sequence information.

As used herein, a “node” is a structure which may contain a value, a condition, or represent a separate data structure (which could be a tree of its own). Each node in a tree has zero or more child nodes, which are below it in the tree (by convention, trees are drawn growing downwards). A node that has a child is called the child's parent node (or ancestor node, or superior). A node typically has at most one parent. As is known, nodes that do not have any children are called leaf nodes or terminal nodes.

The topmost node in a tree is the root node. An internal node or inner node is any node of a tree that has child nodes and is thus is not considered to be a leaf node. Similarly, an external node or outer node is any node that does not have child nodes and is thus a leaf node

A subtree of a tree is a tree consisting of a node in the tree and all of its descendants in the tree. For example, the subtree corresponding to the root node is the entire tree. The subtree that corresponds to any other node may be called a proper subtree.

| | |
|---|---|
| OPTIMIZE TUBES (Ω, Ψ_{Ω}^{on}, Ψ_{Ω}^{off}, Ψ, s_{Ψ}, y_{Ω,Ψ}, R) | OPTIMIZE LEAVES(φ_{A}_{_{D}}, D) |
| Ψ^{active}, Ψ^{passive} ← Ψ^{on}, Ψ^{off} | φ_{A}_{_{D}}, \tilde{M}_{D}^{obj}, \tilde{M}_{Ω,D} ← MUTATELEAVES(φ_{A}_{_{D}}, D) |
| φ_{Ψ}_{^{active}} ← INITSEQ(S_{Ψ}_{^{active}}, R) | mᵣₑₒₚₜ ← 0 |
| A, D ← MAKEFOREST(s_{Ψ}_{^{active}}) | while mᵣₑₒₚₜ < Mᵣₑₒₚₜ and ∃h ∈ Ω:\tilde{M}_{b,D} > f_{b,D}^{stop} |
| φ_{A}, M_{Ω,1} ← OPTIMIZEFOREST(φ_{A}, D) | φ_{A}_{_{D}} ← RESEEDDEQ(φ_{A}_{_{D}}, {M_{Ω,D}^{α}}, R) |
| M^{obj}, M_{Ω} ← EVALUATEDEFECT(φ_{Ψ}, s_{Ψ}, y_{Ω,Ψ}) | φ_{A}_{_{D}}, M_{D}^{obj}, M_{Ω,D} ← MUTATELEAVES(φ_{A}_{_{D}}, D) |
| φ_{Ψ}, M^{obj}, M_{Ω} ← φ_{Ψ}, M^{obj}, M_{Ω} | if M_{D}^{obj} < M_{D}^{obj} |
| while ∃h ∈ Ω:M_{b} > max(f_{b}^{stop}, M_{b,1}) | φ_{A}_{_{D}}, \tilde{M}_{D}^{obj}, \tilde{M}_{Ω,D} ← φ_{A}_{_{D}}, \dot{M}_{D}^{obj}, \dot{M}_{Ω,D} |
| Ψ^{active}, Ψ^{passive} ← REFOCUSTUBES(Ψ^{active}, Ψ^{passive}, \dot{x}_{Ψpassiveα}) | mᵣₑₒₚₜ ← 0 |
| A, D ← AUGMENTFOREST(A, D, \dot{P}_{Ψactive}) | else |
| φ_{A}, \tilde{M}_{Ω,1} ← OPTIMIZEFOREST(φ_{A}, D) | mᵣₑₒₚₜ ← mᵣₑₒₚₜ + 1 |
| M^{obj}, M_{Ω} ← EVALUATEDEFECT(φ_{Ψ}, s_{Ψ}, y_{Ω,Ψ}) | return φ_{A}_{_{D}}, M_{Ω,D} |
| if M^{obj} < M^{obj} | |
| φ_{Ψ}, M^{obj} ← φ_{Ψ}, M^{obj} | MUTATELEAVES(φ_{A}_{_{D}}, D) |
| return φ_{Ψ} | \tilde{M}_{D}^{obj}, \tilde{M}_{Ω,D} ← ESTIMATEDEFECT(φ_{A}_{_{D}}) |
| | γ_{bad} ← , m_{bad} ← 0 |
| OPTIMIZEFOREST(φ_{A}, D) | while m_{bad} < M_{bad} and ∃h ∈ Ω:M_{A,D} > f_{b,D}^{stop} |
| \tilde{M}_{1,...,D}^{obj} ← ∞ | ξ,φ_{A}_{_{D}} ← SAMPLEMUTATION(φ_{A}_{_{D}}, {M_{Ω,D}^{α}}, R) |
| β_{merge} ← false | if ξ ∈ γ_{bad} |
| while βmerge | m_{bad} ← m_{bad} + 1 |
| φ_{A}_{_{D}}, M_{Ω,D} ← OPTIMIZELEAVES(φ_{A}_{_{D}}, D) | else |
| d ← D − 1 | \tilde{M}_{D}^{obj}, \tilde{M}_{Ω,D} ← ESTIMATEDEFECT(φ_{A}_{_{D}}) |
| β_{merge} ← true | if \tilde{M}_{D}^{obj} < \tilde{M}_{D}^{obj} |
| while d ≧ 1 and β_{merge} | φ_{A}_{_{D}}, \tilde{M}_{D}^{obj}, \tilde{M}_{Ω,D} ← φ_{A}_{_{D}}, \dot{M}_{D}^{^{obj}}, \dot{M}_{Ω,D} |
| φ_{A}_{_{d}} ← MERGESEQ(φ_{A}_{_{d11}}) | γ_{bad} ← , m_{bad} ← 0 |
| \dot{M}_{d}^{obj}, M_{Ω,d} ← ESTIMATEDEFECT(φ_{A}_{_{d}}) | else |
| if \dot{M}_{d}^{obj} < \tilde{M}_{d}^{obj} | γ_{bad} ← γ_{bad} ∪ ξ, m_{bad} ← m_{bad} + 1 |
| φ_{A}_{_{d}}, \tilde{M}_{d}^{obj} ← φ_{A}_{_{d}}, \dot{M}_{d}^{obj} | return φ_{A}_{_{D}}, \tilde{M}_{D}^{obj}, \tilde{M}_{Ω,D} |
| while ∃h ∈ Ω:M_{b,d} > max(f_{b,d}^{stop}, M_{b,d+1}/f_{stringeat}) | |
| β_{merge} ← false | ESTIMATEDEFECT(φ_{A}_{_{d}}) |
| A, D ← REDECOMPSEFOREST(A, D, s_{A}_{_{d}}, \dot{P}_{A}_{_{d}}) | \tilde{Q}_{A}_{_{d}}, \tilde{P}_{A}_{_{d}} ← CONDITIONNODALPROPERTIES(φ_{A}_{_{d}}) |
| φ_{A}_{_{D}} ← SPLITSEQ(φ_{A}_{_{d}}) | \tilde{Q}_{Ψactive} ← ESTIMATECOMPLEXPFUNCS(\tilde{Q}_{A}_{_{d}}) |
| \tilde{M}_{d′}^{obj} ← ∞ ∀d′ ∈ {d + 1, . . ., D} | P_{φactive} ← ESTIMATECOMPLEXPAIRPROBS(\tilde{P}_{A}_{_{d}}) |
| d ← d − 1 | for h ∈ Ω |
| return φ_{A}_{₁}, \tilde{M}_{Ω,1} | \tilde{x}_{b,Ψ}_{_{b}}_{^{α}}^{α} ← DEFLATEMASSCONSTRAINTS(x_{b,Ψ}_{_{b}}_{⁰}⁰) |
| | \tilde{x}_{b,Ψ}_{_{b}}_{^{active}} ← ESTIMATECOMPLEXCONCENTRATIONS(\tilde{Q}_{Ψ}_{_{b}}_{^{active}},\tilde{x}_{b,Ψ}_{_{b}}_{⁰}⁰) |
| | ñ_{Ψ}_{_{b}}_{^{on}} ← ESTIMATECOMPLEXDEFECTS(\tilde{P}_{Ψ}_{_{b}}_{^{on}}_{,s}_{_{Ψb}}_{^{on}}) |
| | \tilde{c}_{b,Ψ}_{_{b}}_{^{∞}} ← ESTIMATETUBEDEFECTTERMS(ñ_{Ψ}_{_{b}}_{^{on}}, \tilde{x}_{b,Ψ}_{_{b}}_{^{on}}, y_{b,Ψ}_{_{b}}_{^{on}}) |
| | \tilde{M}_{b,d} = Σ_{j∈Ψ}_{_{b}}_{^{on}}\tilde{c}b,j |
| | ${M}_{d}^{obj} ← \frac{1}{\vert Ω \vert} {Σ}_{b ∈ Ω} max ( {M}_{b , d} , {f}_{b , d}^{Stop} ) \text{?}$ |
| | return \tilde{M}_{d}^{obj}, \tilde{M}_{Ω,d} |

$\text{?} \text{indicates text missing or illegible when filed}$

What is claimed is:

1. An electronic system for determining the suitability of candidate nucleic acid strands to hybridize in solution via a target reaction pathway, comprising:
a set of virtual target test tubes representing reactants, intermediates, or products in the target reaction pathway, each virtual target test tube comprising data representing on-target complexes each having a target secondary structure and a target concentration, and off-target complexes each having vanishing target concentration;
one or more sequence constraints inherent to the reaction pathway;
a mutations module configured to generate a feasible candidate sequence that satisfies the one or more sequence constraints; and
an objective function module configured to calculate a design objective function that quantifies the quality of a feasible candidate sequence based on physical properties calculated over the set of target test tubes.

2. The electronic system of claim 1, wherein the mutations module is configured to generate a feasible candidate sequence by solving a constraint-satisfaction problem specified as a set of variables, a set of domains, and a set of sequence constraints.

3. The electronic system of claim 1, additionally comprising one or more sequence constraints beyond sequence constraints inherent in the reaction pathway.

4. The electronic system of claim 3, wherein one or more sequence constraints are selected from a group consisting of: assignment constraints, match constraints, Watson-Crick constraints, wobble constraints, composition constraints, similarity constraints, pattern prevention constraints, window constraints, and library constraints.

5. The electronic system of claim 3, wherein one or more sequence constraints enforce compatibility with one or more prescribed biological sequences.

6. The electronic system of claim 1, wherein the objective function module is further configured to calculate a normalized test tube ensemble defect and evaluate a test tube stop condition for each target test tube.

7. The electronic system of claim 6, wherein the system is configured to optimize the sequence by reducing the design objective function such that the normalized test tube ensemble defect for each target test tube satisfies a test tube stop condition.

8. The electronic system of claim 1, wherein the objective function module is further configured to calculate a multistate test tube ensemble defect over the set of target test tubes.

9. The electronic system of claim 1, additionally comprising a test tube ensemble focusing module that defines a focused ensemble within each target test tube comprising a subset of the complexes within the target test tube.

10. The electronic system of claim 9, wherein the test tube ensemble focusing module is configured to initially include only on-target complexes in the focused ensemble for each target test tube.

11. The electronic system of claim 10, wherein the test tube ensemble focusing module is configured to augment the focused ensemble of each target test tube with a subset of the off-target complexes in the target test tube.

12. The electronic system of claim 11, wherein the test tube ensemble focusing module is configured so that the off-target complexes selected to augment the focused ensemble within each target test tube are those that form with the highest concentration.

13. The electronic system of claim 9, additionally comprising a hierarchical ensemble decomposition module configured to decompose the structural ensemble of each complex contained in a focused test tube ensemble into a tree of nonredundant subensembles, yielding a forest of decomposition trees.

14. The electronic system of claim 13, wherein the hierarchical ensemble decomposition module is configured to use one split-point to decompose the structural ensemble of each parent node into nonredundant child subensembles.

15. The electronic system of claim 13, wherein the hierarchical ensemble decomposition module is configured to use multiple exclusive split-points to decompose the structural ensemble of each parent node into nonredundant child subensembles.

16. The electronic system of claim 13, wherein the hierarchical ensemble decomposition module is configured to perform structure-guided hierarchical ensemble decomposition.

17. The electronic system of claim 13, wherein the hierarchical ensemble decomposition module is configured to perform probability-guided hierarchical ensemble decomposition.

18. The electronic system of claim 13, wherein the hierarchical ensemble decomposition module is configured to perform structure-guided and probability-guided hierarchical ensemble decomposition.

19. The electronic system of claim 13, additionally comprising an estimations module configured to estimate the physical properties of the target test tubes based on physical properties calculated over the nonredundant subensembles at any level within the forest of decomposition trees.

20. The electronic system of claim 19, wherein the estimations module is configured to estimate a complex partition function, a complex concentration, a complex base-pairing probability matrix, and a complex ensemble defect for complexes at the root level of the forest of decomposition trees based on physical properties calculated at any level within the forest of decomposition trees.

21. The electronic system of claim 19, wherein the estimations module is configured to estimate the normalized test tube ensemble defect for each target test tube and the design objective function based on physical properties calculated at any level within the forest of decomposition trees.

22. The electronic system of claim 19, wherein the estimations module optimizes the sequence by accepting or rejecting a feasible candidate sequence based on physical properties calculated at a leaf level of the forest of decomposition trees.

23. The electronic system of claim 13, wherein the hierarchical ensemble decomposition module is configured to decompose the structural ensemble of each parent node into conditional child subensembles that can be used to reconstruct conditional parent ensembles.

24. The electronic system of claim 23, additionally comprising an estimations module configured to estimate the physical properties of the target test tubes based on conditional physical properties calculated over the conditional subensembles at any level within the decomposition forest.

25. The electronic system of claim 1, wherein each target test tube contains one on-target complex and no off-target complexes.

26. An electronic system for optimizing the sequence of one or more nucleic acid strands to hybridize in solution via a target reaction pathway, comprising:
a set of virtual target test tubes representing reactants, intermediates, or products in the target reaction pathway, each virtual target test tube comprising data representing on-target complexes each having a target secondary structure and a target concentration, and off-target complexes each having a vanishing target concentration;
one or more sequence constraints;
a mutations module configured to generate a feasible candidate sequence that satisfies the one or more sequence constraints;
an objective function module configured to evaluate the quality of a feasible candidate sequence based on physical properties calculated over the set of target test tubes;
a test tube ensemble focusing module configured to define a focused ensemble within each target test tube comprising a subset of the complexes within the target test tube;
a hierarchical ensemble decomposition module configured to decompose each complex in the focused ensemble into a tree of conditional subensembles, yielding a forest of decomposition trees; and
an estimations module configured to optimize the sequence by accepting or rejecting a feasible candidate sequence based on conditional physical properties calculated at any level within the forest of decomposition trees.

27. A computer-implemented method for determining the suitability of candidate nucleic acid strands to hybridize in solution via a target reaction pathway, comprising:
representing reactants, intermediates, or products in the target reaction pathway using a set of virtual target test tubes, each virtual target test tube comprising data representing on-target complexes each having a target secondary structure and a target concentration, and off-target complexes each having vanishing target concentration;
determining one or more sequence constraints inherent to the reaction pathway;
generating a feasible candidate sequence that satisfies the one or more sequence constraints; and
calculating a design objective function that quantifies the quality of a feasible candidate sequence based on physical properties calculated over the set of target test tubes.

28. The computer-implemented method of claim 27, further comprising generating a feasible candidate sequence by solving a constraint-satisfaction problem specified as a set of variables, a set of domains, and a set of sequence constraints.

29. The computer-implemented method of claim 27, further comprising receiving one or more sequence constraints beyond sequence constraints inherent in the reaction pathway.

30. The computer-implemented method of claim 27, further comprising calculating a normalized test tube ensemble defect and evaluating a test tube stop condition for each target test tube.

31. The computer-implemented method of claim 27, further comprising calculating a multistate test tube ensemble defect over the set of target test tubes.

32. The computer-implemented method of claim 27, further comprising defining a focused ensemble within each target test tube comprising a subset of the complexes within the target test tube.
